(19) United States
(12) Patent Application Publication
(10) Pub. No.: US 2025/0299884 A1
(43) Pub. Date: Sep. 25, 2025

(54) MULTILAYER CERAMIC CAPACITOR

(71) Applicant: Murata Manufacturing Co., Ltd., Nagaokakyo-shi (JP)

(72) Inventor: Masaki ITOGAWA, Nagaokakyo-shi (JP)

(21) Appl. No.: 19/081,299

(22) Filed: Mar. 17, 2025

(30) Foreign Application Priority Data
Mar. 25, 2024 (JP) 2024-048097

(51) Int. Cl. H01G 4/232; H01G 4/008; H01G 4/012; H01G 4/12

(52) U.S. Cl. CPC H01G 4/232; H01G 4/008; H01G 4/012; H01G 4/1236

(57) ABSTRACT

A multilayer ceramic capacitor includes first, second, third, and fourth main surface-side external electrodes respectively including first, second, third, and fourth recesses recessed toward a multilayer body. In a cross-sectional view along a length direction and a lamination direction, an intersection of a first virtual line connecting the first recess and the fourth recess and a second virtual line connecting the second recess and the third recess is located between a first capacitor portion and a second capacitor portion in the length direction. External electrodes each having tensile stress as a residual stress are provided.

### CROSS REFERENCE TO RELATED APPLICATIONS

This application claims the benefit of priority to Japanese Patent Application No. 2024-048097 filed on Mar. 25, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In the prior art, as multilayer ceramic capacitors each achieving high breakdown voltage, multilayer ceramic capacitors have been known that each include a configuration in which a plurality of capacitor portions connected in series are provided, that is, multilayer ceramic capacitors each including a series configuration (see, for example, Japanese Unexamined Patent Application, Publication No. H10-261546).

In the multilayer ceramic capacitors each including such a series structure, a large electrostriction is also generated between the capacitor portions connected in series, and a force (tensile stress) in the stacking or lamination direction from the middle of the multilayer body toward the main surface is generated in the multilayer body. Further, when the external electrode has tensile stress as residual stress, a force (tensile stress) from the middle of the multilayer body toward the end portion of the external electrode remains in the multilayer body. Among these forces, a force in the lamination direction from the middle of the multilayer body toward the main surface is combined, and when the combined force increases, delamination of the multilayer body may occur.

### SUMMARY OF THE INVENTION

Example embodiments of the present invention provide multilayer ceramic capacitors that are each able to reduce or prevent the occurrence of delamination in a multilayer body in a multilayer ceramic capacitor including a high breakdown voltage specification.

A multilayer ceramic capacitor according to an example embodiment of the present invention includes a multilayer body including a plurality of dielectric layers and a plurality of internal electrode layers alternately laminated in a height direction, a first main surface and a second main surface opposed to each other in the height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, and a pair of external electrodes each on one of two end portions of the multilayer body in the length direction, and spaced apart from each other. The plurality of internal electrode layers include a plurality of first internal electrode layers extending toward and exposed at the first end surface, a plurality of second internal electrode layers extending toward and exposed at the second end surface, and a plurality of intermediate electrode layers not extending toward and not exposed at either of the first end surface or the second end surface. The multilayer body includes a first capacitor portion including the plurality of: first internal electrode layers and the plurality of intermediate electrode layers opposed to each other, and a second capacitor portion including the plurality of second internal electrode layers and the plurality of intermediate electrode layers opposed to each other. The pair of external electrodes include a first external electrode provided on and adjacent to the first end surface, and a second external electrode provided on and adjacent to the second end surface. The first external electrode includes a first main surface-side external electrode on the first main surface and a second main surface-side external electrode on the second main surface. The second external electrode includes a third main surface-side external electrode on the first main surface and a fourth main surface-side external electrode on the second main surface. The first main surface-side external electrode includes a first recess recessed toward the multilayer body. The second main surface-side external electrode includes a second recess recessed toward the multilayer body. The third main surface-side external electrode includes a third recess recessed toward the multilayer body. The fourth main surface-side external electrode includes a fourth recess recessed toward the multilayer body. In a cross sectional view along the length direction and the height direction, an intersection between a first virtual line connecting the first recess and the fourth recess and a second virtual line connecting the second recess and the third recess is located between the first capacitor portion and the second capacitor portion in the length direction. The pair of external electrodes each have tensile stress as a residual stress.

According to example embodiments of the present invention, it is possible to provide multilayer ceramic capacitors that are each able to reduce or prevent the occurrence of delamination in a multilayer body in a multilayer ceramic capacitor including a high breakdown voltage specification.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a two-portion multilayer ceramic capacitor according to an example embodiment of the present invention.

FIG. 2 is a cross-sectional view taken along the line II-II of FIG. 1, and is a view for explaining a general configuration of a two-portion multilayer body according to an example embodiment of the present invention.

FIG. 3 is a cross-sectional view taken along the line III-III of FIG. 2.

FIG. 4A is a cross-sectional view taken along the line IVA-IVA of FIG. 2, and is a cross-sectional view taken along a first internal electrode layer and a second internal electrode layer.

FIG. 4B is a cross-sectional view taken along the line IVB-IVB of FIG. 2, and is a cross-sectional view taken along an intermediate electrode layer.

FIG. 5A is a view showing a portion of a method of manufacturing a multilayer ceramic capacitor according to an example embodiment of the present invention, and is a view showing a first step of forming an external electrode on a multilayer body.

FIG. 5B is a view showing a portion of a method of manufacturing a multilayer ceramic capacitor according to an example embodiment of the present invention, and is a view showing a second step of forming an external electrode on a multilayer body.

FIG. 5C is a view showing a portion of a method of manufacturing a multilayer ceramic capacitor according to an example embodiment of the present invention, and is a view showing a third step of forming an external electrode on the multilayer body.

FIG. 6 is an LT cross-sectional view schematically showing a two-portion multilayer ceramic capacitor according to an example embodiment of the present invention, and is a view for explaining a force acting inside a multilayer ceramic capacitor.

FIG. 7 is an LT cross-sectional view schematically showing a three-portion multilayer ceramic capacitor according to a first modification of an example embodiment of the present invention.

FIG. 8 is an LT cross-sectional view schematically showing a four-portion multilayer ceramic capacitor according to a second modification of an example embodiment of the present invention.

### DETAILED DESCRIPTION OF THE EXAMPLE EMBODIMENTS

Hereinafter, multilayer ceramic capacitors according to example embodiments of the present invention will be described in detail below with reference to the drawings. However, the present invention is not limited thereto.

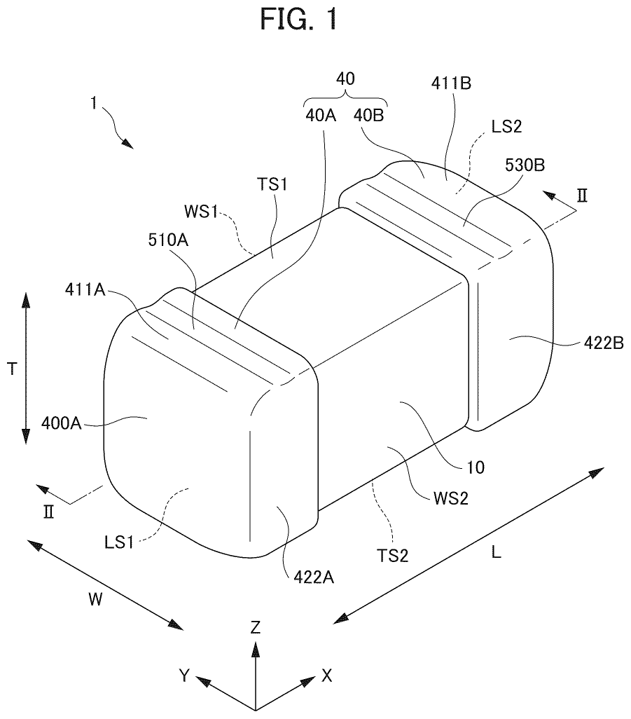

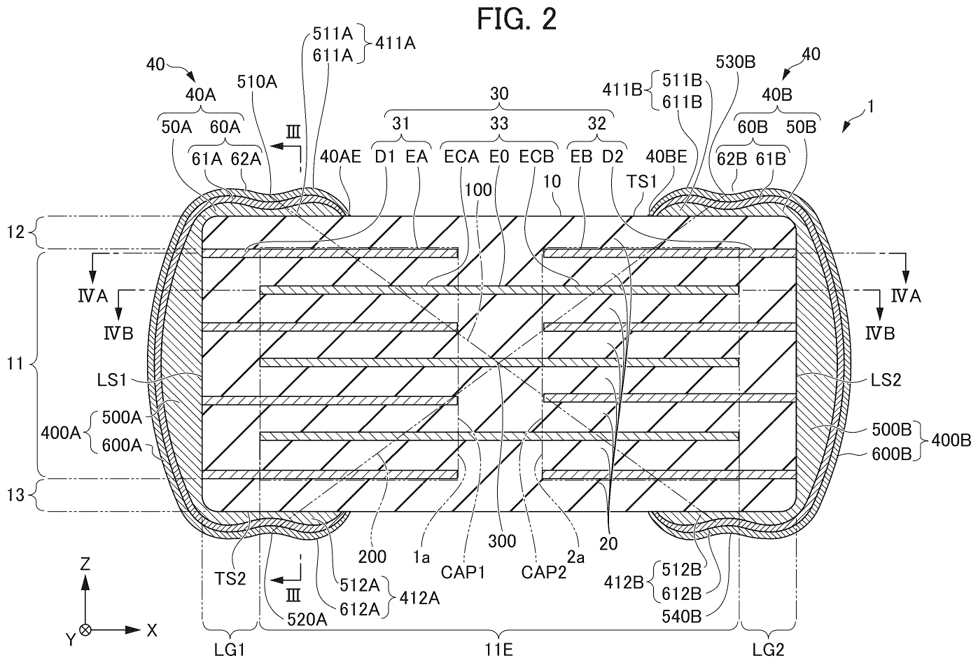

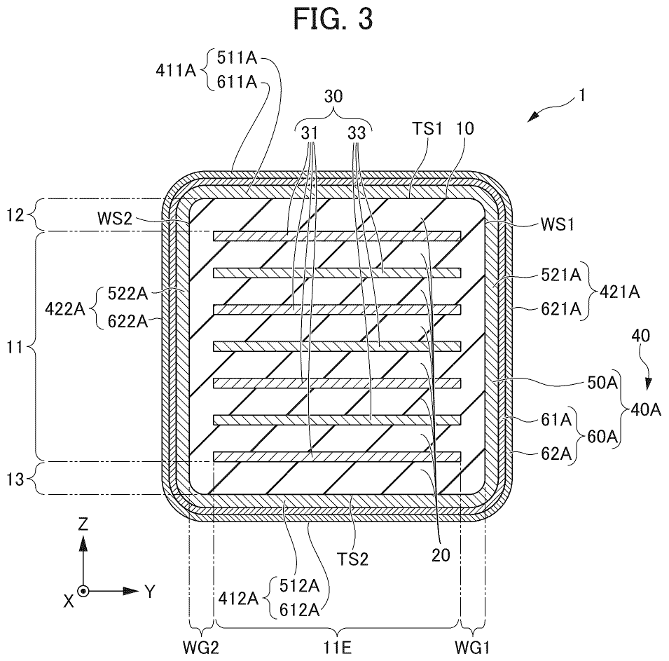

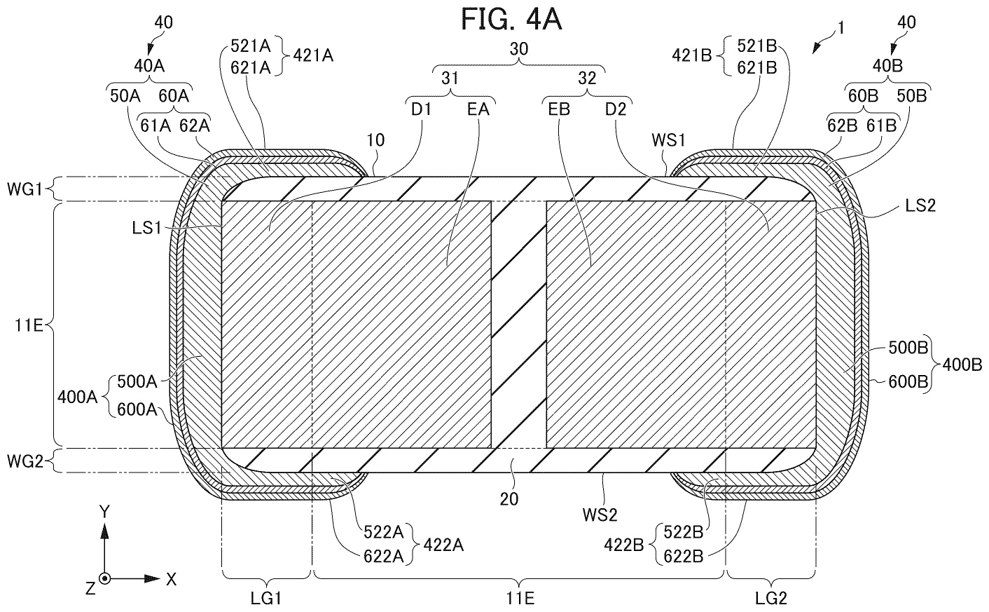

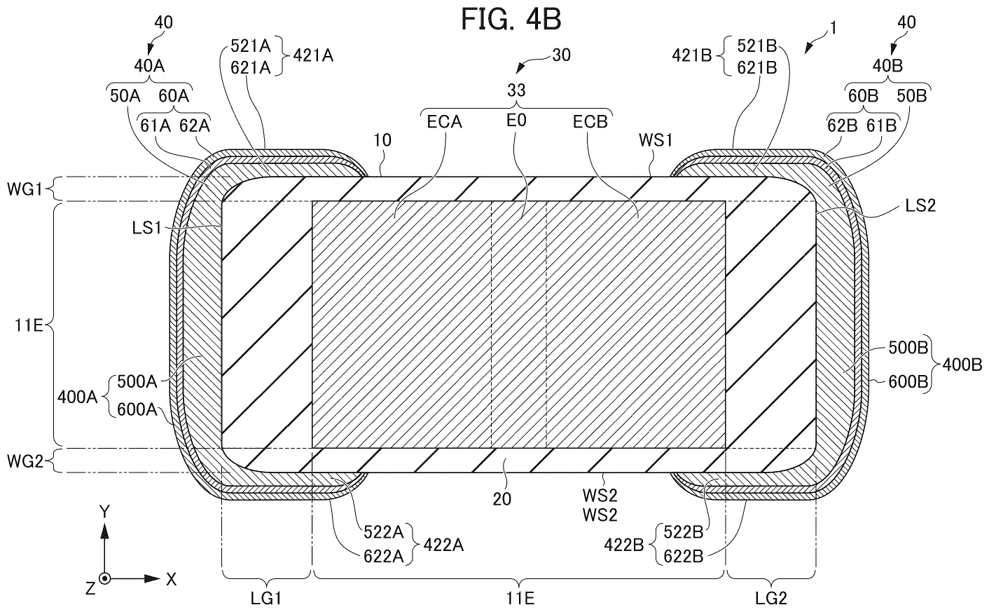

A two-portion multilayer ceramic capacitor 1 according to an example embodiment of the present invention will be described with reference to the drawings. The multilayer ceramic capacitor 1 of the present example embodiment has a small rate of change in electrostatic capacitance due to a change in temperature, and is a capacitor for temperature compensation used to match a filter and a high frequency circuit. However, the multilayer ceramic capacitor 1 is not limited thereto. FIG. 1 is an external perspective view of a two-portion multilayer ceramic capacitor 1 according to an example embodiment of the present invention. FIG. 2 is a cross-sectional view taken along the line II-II of FIG. 1, and is a view for explaining a general configuration of the two-portion multilayer body according to the present example embodiment. FIG. 3 is a cross-sectional view taken along the line III-III of FIG. 2. FIG. 4A is a cross-sectional view taken along the line IVA-IVA of FIG. 2, and is a cross-sectional view taken along a first internal electrode layer and a second internal electrode layer. FIG. 4B is a cross-sectional view taken along the line IVB-IVB of FIG. 2, and is a cross-sectional view taken along an intermediate electrode layer.

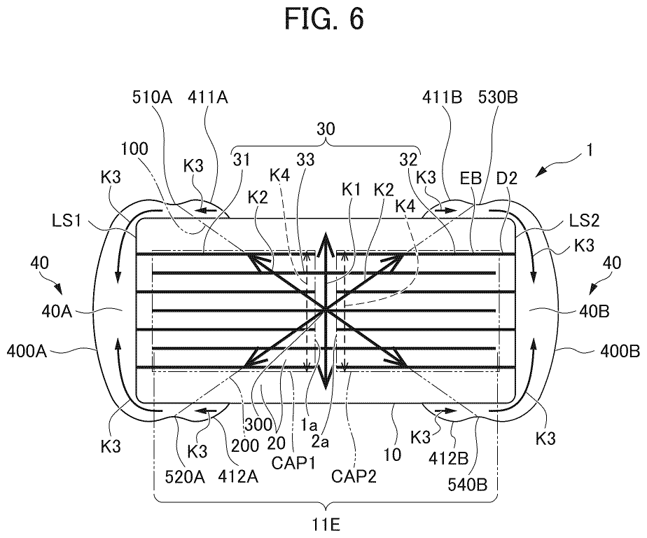

In addition, the drawings may be schematically simplified and drawn in order to explain the contents of example embodiments of the present invention, and the drawn components or the ratio of the dimensions between the elements may not coincide with the ratio of the dimensions described in the specification. In addition, components described in the specification may be omitted in the drawings or may be drawn with the number of pieces of components omitted. For example, although the number of internal electrode layers shown in FIGS. 2 and 3 is seven for convenience of description, this does not indicate the actual number of internal electrode layers 30. The same applies to FIGS. 6 to 8. Terms used in the present disclosure, such as “parallel”, “orthogonal”, “same”, and the like, and values of lengths and angles, and the like, which specify shapes, geometrical conditions, and degrees thereof, are not limited to strict meanings, and should be interpreted to include a range in which similar functions can be provided.

As shown in FIG. 1, the shape of the multilayer ceramic capacitor 1 according to an example embodiment is rectangular or substantially rectangular parallelepiped. The multilayer ceramic capacitor 1 includes a rectangular or substantially rectangular parallelepiped multilayer body 10 and a pair of external electrodes 40 spaced apart from each other at both ends of the multilayer body 10.

In FIG. 1, the arrow T indicates the lamination direction, as the height direction, of the multilayer ceramic capacitor 1 and the multilayer body 10. The lamination direction T also represents the thickness direction of the multilayer ceramic capacitor 1 and the multilayer body 10. In FIG. 1, the arrow L indicates the length direction of the multilayer ceramic capacitor 1 and the multilayer body 10, in which the length direction is orthogonal or substantially orthogonal to the lamination direction T. In FIG. 1, the arrow W indicates the width direction of the multilayer ceramic capacitor 1 and the multilayer body 10, in which the width direction is orthogonal or substantially orthogonal to both the lamination direction T and the length direction L. The pair of external electrodes 40 are provided at both ends of the multilayer body 10 in the length direction L.

FIGS. 1 to 4B illustrate an XYZ Cartesian coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination direction T of the multilayer ceramic capacitor 1 and the multilayer body 10 corresponds to the Z direction. The cross section shown in FIG. 2 is also referred to as an LT cross section. The cross section shown in FIG. 3 is also referred to as a WT cross section. The cross section shown in FIGS. 4A and 4B is also referred to as an LW cross section.

As shown in FIGS. 1 to 4B, the multilayer body 10 includes a first main surface TS1 and a second main surface TS2 on opposite sides in the lamination direction T, a first end surface LS1 and a second end surface LS2 on opposite sides in the length direction L orthogonal or substantially orthogonal to the lamination direction T, and a first lateral surface WS1 and a second lateral surface WS2 on opposite sides in the width direction W orthogonal or substantially orthogonal to both the lamination direction T and the length direction L.

As shown in FIG. 1, the shape of the multilayer body 10 is rectangular or substantially rectangular parallelepiped. The dimension in the length direction L of the multilayer body 10 is not necessarily longer than the dimension in the width direction W. The corner portions and edge portions of the multilayer body 10 are preferably rounded. The corner portions are where three faces of the multilayer body intersect, and the edge portions are where two faces of the multilayer body intersect. The surfaces of the multilayer body 10 may include irregularities in a portion of an entirety thereof.

The dimensions of the multilayer body 10 are not particularly limited. However, the dimension of the multilayer body 10 in the length direction L, denoted as the L dimension, is, for example, preferably between 0.2 mm and 10 mm inclusive. The dimension of the multilayer body 10 in the lamination direction T, denoted as the T dimension, is, for example, preferably between 0.1 mm and 10 mm inclusive. The dimension of the multilayer body 10 in the width direction W, denoted as the W dimension, is, for example, preferably between 0.1 mm and 10 mm inclusive.

As shown in FIGS. 2 and 3, the multilayer body 10 includes an inner layer portion 11, and first and second main surface-side outer layer portions 12 and 13 sandwiching the inner layer portion 11 in the lamination direction T.

The inner layer portion 11 includes a plurality of dielectric layers 20 and a plurality of internal electrode layers 30, both of which are laminated alternately in the lamination direction T. The inner layer portion 11 includes the internal electrode layers 30, including an internal electrode layer 30 closest to the first main surface TS1 to an internal electrode layer 30 closest to the second main surface TS2, in the lamination direction T. In the inner layer portion 11, the plurality of internal electrode layers 30 are opposed to each other sandwiching the dielectric layers 20. The inner layer portion 11 defines and functions to generate capacitance, and essentially operates as a capacitor.

The plurality of dielectric layers 20 are made of dielectric materials. As described above, the multilayer ceramic capacitor 1 according to the present example embodiment is, for example, a temperature compensation capacitor, and the dielectric material is, for example, a CaZro₃-based dielectric material (hereinafter, sometimes referred to as a CZ-based dielectric material) or a Ca(Sr,Zr)O₃-based dielectric material (hereinafter, sometimes referred to as a CSZ-based dielectric material). The CZ-based and CSZ-based dielectric materials include a perovskite compound including, for example, at least Ca and Zr. The CZ-based dielectric material is a material system including not only CaZro₃, but also a CaZro₃ solid solution in which a portion of Ca, a portion of Zr, or a portion of Ca and Zr is substituted with an appropriate element. The dielectric material includes, for example, at least one of Ca (calcium), Zr (zirconium), or Ti (titanium). As an example, the dielectric layer 20 includes a perovskite compound including Ca and Zr, and optionally including Sr and Ti. Specifically, for example, the dielectric layer 20 includes CaZro₃ (calcium zirconate), CaTiO₃ (calcium titanate), SrTiO₃ (strontium titanate), BaZro₃ (proton conductive metal oxide), titanium oxide (TiO₂), or the like. Usually, in the multilayer ceramic capacitor 1, oxygen vacancies are generated by firing in a reducing atmosphere, but in particular, CaZro₃ has a high band gap, so that the generation of oxygen vacancies can be reduced or prevented. As a result, high reliability can be obtained. The dielectric material may be obtained by adding an auxiliary component such as, for example, a Mn compound, a Fe compound, a Cr compound, a Co compound, or a Ni compound to these main components.

Since the dielectric layer 20 of the present example embodiment includes a material including at least one of, for example, Ca (calcium), Zr (zirconium), or Ti (titanium), it has a relative permittivity of, for example, about 20 to about 300 and has a smaller capacitance than that of a high permittivity system. In addition, the dielectric layer 20 of the present example embodiment has a characteristic such that the relative permittivity changes substantially linearly with temperature, and is excellent in heat resistance and high-frequency characteristics. Further, the dielectric layer 20 of the present example embodiment has a small change in the capacitance value with time so as to be negligible, and has a small loss of the capacitor even at a high temperature, high power, and high frequency, and thus is excellent in stability. In addition, the dielectric layer 20 has a small change in permittivity with time or due to voltage application. In addition, the dielectric material is not limited to this, and may be, for example, a high permittivity ceramic such as, for example, a BaTiO₃-based (BT-based) ceramic.

The thickness of the dielectric layer 20 is, for example, preferably about 0.2 μm or more and about 15 μm or less. In particular, for example, the thickness of the dielectric layer 20 is preferably about 3 μm or more and about 10 μm or less. The number of dielectric layers 20 to be laminated is, for example, preferably 15 or more and 1200 or less. The number of dielectric layers 20 is the total of the number of dielectric layers 20 in the inner layer portion 11, and the number of the dielectric layers 20 in the first main surface-side outer layer portion 12 and the second main surface-side outer layer portion 13.

The plurality of internal electrode layers 30 include a plurality of first internal electrode layers 31, a plurality of second internal electrode layers 32, and an intermediate electrode layer 33. The first internal electrode layers 31 and the second internal electrode layers 32 are adjacently spaced apart in the length direction L. The first and second internal electrode layers 31 and 32 and the intermediate electrode layer 33 are alternately provided in the lamination direction T sandwiching the dielectric layers 20 therebetween.

The first internal electrode layers 31 extend to the first end surface LS1, and are connected to a first external electrode 40A (to be described later). The second internal electrode layers 32 extend to the second end surface LS2, and are connected to a second external electrode 40B (to be described later). The intermediate electrode layer 33 does not extend to either the first end surface LS1 or the second end surface LS2, and is not connected to either the first external electrode 40A or the second external electrode 40B. The series-connected capacitor elements are defined by the first internal electrode layers 31, the intermediate electrode layer 33, and the second internal electrode layers included in the plurality of internal electrode layers 30. Hereinafter, unless necessary to distinguish, the first internal electrode layers 31, the second internal electrode layers 32, and the intermediate electrode layer 33 may collectively be referred to as the internal electrode layers 30.

As shown in FIGS. 2 and 4A, the first internal electrode layer 31 includes a first counter portion EA and a first extension portion D1. The first counter portion EA is opposed to the intermediate electrode layer 33 adjacent in the lamination direction T, sandwiching the dielectric layer 20 therebetween, provided inside the multilayer body 10. The first internal electrode layer 31 includes the first counter portion EA that is connected to the first extension portion D1, and is opposed to another internal electrode layer 30 adjacent in the lamination direction T. The first extension portion D1 extends from the first counter portion EA to the first end surface LS1, and is exposed at the first end surface LS1. The first internal electrode layer 31 includes the first extension portion D1, one end of which extends to the first end surface LS1 and is connected to the first external electrode 40A.

As shown in FIGS. 2 and 4A, the second internal electrode layer 32 includes a second counter portion EB and a second extension portion D2. The second counter portion EB is opposed to the intermediate electrode layer 33 adjacent in the lamination direction T, sandwiching the dielectric layer 20 therebetween, provided inside the multilayer body 10. The second internal electrode layer 32 includes the second counter portion EB that is connected to the second extension portion D2, and is opposed to another internal electrode layer 30 adjacent in the lamination direction T. The second extension portion D2 extends from the second counter portion EB to the second end surface LS2, and is exposed at the second end surface LS2. The second internal electrode layer 32 includes the second extension portion D2, one end of which extends to the second end surface LS2 and is connected to the second external electrode 40B.

As shown in FIGS. 2 and 4B, the intermediate electrode layer 33 includes a first electrode layer-side counter portion ECA, a second electrode layer-side counter portion ECB, and a coupling portion E0. The first electrode layer-side counter portion ECA is opposed to the first internal electrode layer 31 adjacent in the lamination direction T, sandwiching a dielectric layer 20 therebetween, provided inside the multilayer body 10. The second electrode layer-side counter portion ECB is opposed to the second internal electrode layer 32 adjacent in the lamination direction T, sandwiching the dielectric layer 20 therebetween, provided inside the multilayer body 10. The coupling portion E0 couples the first electrode layer-side counter portion ECA and the second electrode layer-side counter portion ECB with each other, and is provided between the first electrode layer-side counter portion ECA and the second electrode layer-side counter portion ECB.

In the multilayer ceramic capacitor 1 according to the present example embodiment, the end portion adjacent to the first end surface LS1 of the intermediate electrode layer 33 is spaced apart from the first end surface LS1. In the multilayer ceramic capacitor 1 according to the present example embodiment, the end portion adjacent to the first end surface LS1 of the intermediate electrode layer 33 is located closer to the first end surface LS1 than to the end portion 40AE of the first external electrode 40A. However, this arrangement is not limiting. The end portion adjacent to the first end surface LS1 of the intermediate electrode layer 33 may also be closer to the second end surface LS2 than to the end portion 40AE of the first external electrode 40A.

The end portion adjacent to the second end surface LS2 of the intermediate electrode layer 33 is spaced apart from the second end surface LS2. In the multilayer ceramic capacitor 1 according to the present example embodiment, the end portion adjacent to the second end surface LS2 of the intermediate electrode layer 33 is located closer to the second end surface LS2 than to the end portion 40BE of the second external electrode 40B. However, this arrangement is not limiting. The end portion adjacent to the second end surface LS2 of the intermediate electrode layer 33 may also be located closer to the first end surface LS1 than to the end portion 40BE of the second external electrode 40B.

As shown in FIG. 2, in the multilayer ceramic capacitor 1 according to the present example embodiment, the first internal electrode layer 31 and the second internal electrode layer 32 are provided adjacent to each other in the length direction L. In the multilayer ceramic capacitor 1 according to the present example embodiment, the first internal electrode layers 31 and the second internal electrode layers 32 are laminated alternately to overlap the intermediate electrode layer 33, sandwiching the dielectric layers 20.

In the multilayer ceramic capacitor 1 of the present example embodiment, the first counter portion EA and the first electrode layer-side counter portion ECA of the intermediate electrode layer 33 are opposed to each other, sandwiching the dielectric layer 20, such that the capacitance CAP1 is generated. Hereinafter, a portion that generates the capacitance CAP1 is referred to as a first capacitor portion CAP1.

In the multilayer ceramic capacitor 1 of the present example embodiment, the second counter portion EB and the second electrode layer-side counter portion ECB of the intermediate electrode layer 33 are opposed to each other, sandwiching the dielectric layer 20, such that the capacitance CAP2 is generated. Hereinafter, a portion that generates the capacitance CAP2 is referred to as a second capacitor portion CAP2.

That is, the multilayer body 10 includes the first capacitor portion CAP1 defined by the first internal electrode layer 31 and the intermediate electrode layer 33 opposed to each other, and the second capacitor portion CAP2 defined by the second internal electrode layer 32 and the intermediate electrode layer 33 opposed to each other. In FIG. 2, rectangular or substantially rectangular regions of the first capacitor portion CAP1 and the second capacitor portion CAP2 in the LT cross-sectional view are indicated by two-dot chain lines. The coupling portion E0 connects the first capacitor portion CAP1 and the second capacitor portion CAP2 in series. The multilayer ceramic capacitor 1 of the present example embodiment is a two-portion series-configured multilayer ceramic capacitor 1, in which two capacitor portions (the first capacitor portion CAP1 and the second capacitor portion CAP2) are connected in series.

The first capacitor portion CAP1 includes a portion 1a adjacent to the second end surface LS2. The portion 1a adjacent to the second end surface LS2 refers to a portion corresponding to an end surface opposed to the second end surface LS2 in the first capacitor portion CAP1 and the vicinity of the portion corresponding to the end surface.

The second capacitor portion CAP2 includes a portion 2a adjacent to the first end surface LS1. The portion 2a adjacent to the first end surface LS1 refers to a portion corresponding to an end surface opposed to the first end surface LS1 in the second capacitor portion CAP2 and the vicinity of the portion corresponding to the end surface.

The shapes of the first counter portion EA, the second counter portion EB, the first electrode layer-side counter portion ECA, and the second electrode layer-side counter portion ECB are not particularly limited but are preferably rectangular or substantially rectangular. However, the corner portions of the rectangular or substantially rectangular shape may be rounded or may extend diagonally. The shapes of the first extension portion D1 and the second extension portion D2 are not particularly limited but are preferably rectangular or substantially rectangular. Again, the corner portions of the rectangular shape may be rounded or may extend diagonally. The shape of the coupling portion E0 is not particularly limited but is preferably rectangular or substantially rectangular.

The dimensions of the first counter portion EA and the first extension portion D1 in the width direction W may be the same or substantially same, or either one of the dimensions may be smaller. The dimensions of the second counter portion EB and the second extension portion D2 in the width direction W may be the same or substantially same, or either one of the dimensions may be smaller. The dimensions of the first and second electrode layer-side counter portions ECA and ECB and the coupling portion E0 in the width direction W may be the same or substantially same, or either one of the dimensions may be smaller.

The first internal electrode layer 31, the second internal electrode layer 32, and the intermediate electrode layer 33 may be made of suitable electrically conductive materials such as, for example, metals including Ni, Cu, Ag, Pd, Au, or alloys including at least one of these metals. When alloys are used, the first internal electrode layer 31, the second internal electrode layer 32, and the intermediate electrode layer 33 may be made of, for example, an Ag—Pd alloy.

The thickness of the first internal electrode layer 31, the second internal electrode layer 32, and the intermediate electrode layer 33 is, for example, preferably between about 0.2 μm and about 2.0 μm inclusive. The total number of the first internal electrode layer 31, the second internal electrode layer 32, and the intermediate electrode layer 33 combined is, for example, preferably between 10 and 1000 inclusive.

As shown in FIGS. 2 and 3, the first main surface-side outer layer portion 12 is provided adjacent to the first main surface TS1 of the multilayer body 10. The first main surface-side outer layer portion 12 is a collective portion including the plurality of dielectric layers 20 between the first main surface TS1 and the internal electrode layer 30 closest to the first main surface TS1. On the other hand, the second main surface-side outer layer portion 13 is provided adjacent to the second main surface TS2 of the multilayer body 10. The second main surface-side outer layer portion 13 is a collective portion including the plurality of dielectric layers 20 between the second main surface TS2 and the internal electrode layer 30 closest to the second main surface TS2. The dielectric layers 20 used for the first main surface-side outer layer portion 12 and the second main surface-side outer layer portion 13 may be the same or substantially same as the dielectric layers 20 used for the inner layer portion 11.

The multilayer body 10 includes a series capacitor forming portion 11E. The series capacitor forming portion 11E includes the first capacitor portion CAP1, the second capacitor portion CAP2, and the coupling portion E0 of the intermediate electrode layer 33 connecting the first capacitor portion CAP1 and the second capacitor portion CAP2 in series. The series capacitor forming portion 11E is a portion of the inner layer portion 11. FIGS. 4A and 4B show the range of the series capacitor forming portion 11E in the width direction W and the length direction L. In the series capacitor forming portion 11E, the first capacitor portion CAP1 and the second capacitor portion CAP2 are also referred to as capacitor effective portions.

The multilayer body 10 includes lateral surface-side outer layer portions. The lateral surface-side outer layer portions include a first lateral surface-side outer layer portion WG1 and a second lateral surface-side outer layer portion WG2. The first lateral surface-side outer layer portion WG1 is a portion including the dielectric layers 20 between the series capacitor forming portion 11E and the first lateral surface WS1. The second lateral surface-side outer layer portion WG2 is a portion including the dielectric layers 20 between the series capacitor forming portion 11E and the second lateral surface WS2. FIGS. 3, 4A, and 4B show the range of the first lateral surface-side outer layer portion WG1 and the second lateral surface-side outer layer portion WG2 in the width direction W. These lateral surface-side outer layer portions are also referred to as W gaps or side gaps.

The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 and the first extension portion D1, provided between the series capacitor forming portion 11E and the first end surface LS1. In other words, the first end surface-side outer layer portion LG1 is a collective portion including a portion of the plurality of dielectric layers 20 adjacent to the first end surface LS1 and the plurality of first extension portions D1. The second end surface-side outer layer portion LG2 is a portion including the dielectric layers 20 and the second extension portion D2, provided between the series capacitor forming portion 11E and the second end surface LS2. In other words, the second end surface-side outer layer portion LG2 is a collective portion including a portion of the plurality of dielectric layers 20 adjacent to the second end surface LS2 and the plurality of second extension portions D2. FIGS. 2, 4A, and 4B show the range of the first end surface-side outer layer portion LG1 and the second end surface-side outer layer portion LG2 in the length direction L. The end surface-side outer layer portions are also referred to as L-gaps or end gaps.

The series capacitor forming portion 11E of the multilayer body 10 includes a series connection region. The series connection region is a portion including the dielectric layer 20 and the coupling portion E0 located between the first capacitor portion CAP1 and the second capacitor portion CAP2. That is, the series connection region is a collective portion including the middle portion of the plurality of dielectric layers 20 in the length direction L, and the plurality of coupling portions E0. The series connection region is also referred to as an intermediate gap.

As shown in FIGS. 1 and 2, the external electrodes 40 include the first external electrode 40A on and adjacent to the first end surface LS1 of the multilayer body 10, and the second external electrode 40B on and adjacent to the second end surface LS2 of the multilayer body 10.

The basic configurations of the first external electrode 40A and the second external electrode 40B are the same or substantially same. The shape of the first external electrode 40A and the second external electrode 40B is generally plane-symmetrical with respect to the WT cross section in the middle of the multilayer ceramic capacitor 1 in the length direction L. Therefore, unless necessary to distinguish, the first external electrode 40A and the second external electrode 40B may collectively be referred to as the external electrodes 40.

The first external electrode 40A is provided on the first end surface LS1. The first external electrode 40A is in contact with the first extension portions D1 of the plurality of first internal electrode layers 31 exposed at the first end surface LS1. Consequently, the first external electrode 40A is electrically connected to the plurality of first internal electrode layers 31. The first external electrode 40A may also be provided on a portion of the first main surface TS1, a portion of the second main surface TS2, a portion of the first lateral surface WS1, and a portion of the second lateral surface WS2. In the present example embodiment, the first external electrode 40A extends from the first end surface LS1 to a portion of the first main surface TS1, a portion of the second main surface TS2, a portion of the first lateral surface WS1, and a portion of the second lateral surface WS2.

The second external electrode 40B is provided on the second end surface LS2. The second external electrode 40B is in contact with each of the second extension portions D2 of the plurality of second internal electrode layers 32 exposed at the second end surface LS2. Consequently, the second external electrode 40B is electrically connected to the plurality of second internal electrode layers 32. The second external electrode 40B may be provided on a portion of the first main surface TS1, a portion of the second main surface TS2, a portion of the first lateral surface WS1, and a portion of the second lateral surface WS2. In the present example embodiment, the second external electrode 40B extends from the second end surface LS2 to a portion of the first main surface TS1, a portion of the second main surface TS2, a portion of the first lateral surface WS1, and a portion of the second lateral surface WS2.

As previously described, within the multilayer body 10, the first counter portion EA of the first internal electrode layer 31 is opposed to the first electrode layer-side counter portion ECA of the intermediate electrode layer 33, sandwiching the dielectric layer 20 therebetween, such that the capacitance CAP1 is generated. The second counter portion EB of the second internal electrode layer 32 is opposed to the second electrode layer-side counter portion ECB of the intermediate electrode layer 33, sandwiching the dielectric layer 20 therebetween, such that the capacitance CAP2 is generated.

The coupling portion E0 connects the first capacitor portion CAP1 and the second capacitor portion CAP2 in series. Therefore, capacitor characteristics of the series-connected capacitance are generated between the first external electrode 40A connected to the first internal electrode layer 31 and the second external electrode 40B connected to the second internal electrode layer 32.

As shown in FIG. 2, the first external electrode 40A includes a first base electrode layer 50A, and a first plated layer 60A on the first base electrode layer 50A. Similarly, the second external electrode 40B includes a second base electrode layer 50B, and a second plated layer 60B on the second base electrode layer 50B.

The first base electrode layer 50A is provided on the first end surface LS1. The first base electrode layer 50A is connected to the first extension portions D1 of the plurality of first internal electrode layers 31 exposed at the first end surface LS1. In the present example embodiment, the first base electrode layer 50A extends from the first end surface LS1 to a portion of the first main surface TS1, a portion of the second main surface TS2, a portion of the first lateral surface WS1, and a portion of the second lateral surface WS2.

The second base electrode layer 50B is provided on the second end surface LS2. The second base electrode layer 50B is in contact with the second extension portions D2 of the plurality of second internal electrode layers 32 exposed at the second end surface LS2. In the present example embodiment, the second base electrode layer 50B extends from the second end surface LS2 to a portion of the first main surface TS1, a portion of the second main surface TS2, a portion of the first lateral surface WS1, and a portion of the second lateral surface WS2.

The first base electrode layer 50A and the second first base electrode layer 50B include at least one of, for example, a fired layer, a thin film layer, etc.

The first base electrode layer 50A and the second base electrode layer 50B of the present example embodiment are fired layers. The fired layer preferably includes a metal component and either a glass component or a ceramic component, or both. The metal component may include, for example, at least one of Cu, Ni, Ag, Pd, Ag—Pd alloy, or Au. The glass component may include, for example, at least one of B, Si, Ba, Mg, Al, or Li. The ceramic component may use the same ceramic material as the dielectric layer 20 or a different type of ceramic material. The ceramic component includes, for example, at least one of CaZro₃ (calcium zirconate), CaTiO (calcium titanate), SrTiO₃ (strontium titanate), BaZrO₃ (proton conductive metal oxide), titanium oxide (TiO₂), or the like.

The fired layer is formed by applying an electrically conductive paste including glass and metal to the multilayer body 10, followed by firing. The fired layer can be formed by simultaneously firing a pre-firing multilayer chip, which is a material of the multilayer body 10 including the plurality of internal electrode layers and dielectric layers, and the electrically conductive paste applied to the multilayer chip. Alternatively, the fired layer can be formed by obtaining the multilayer body 10 by firing the multilayer chip and then applying the electrically conductive paste to the multilayer body 10, followed by firing. In the case as described above, the fired layer is preferably formed by firing a mixture including ceramic material instead of a glass component. In this case, as the ceramic material to be added, using a ceramic material the same as or similar to the dielectric layer 20 is particularly preferable. The fired layer may include a plurality of layers.

The thickness of the first base electrode layer 50A provided on the first end surface LS1 in the length direction L is, for example, preferably between about 2 μm and about 220 μm inclusive in the middle of the first base electrode layer 50A in the lamination direction T and the width direction W.

The thickness of the second base electrode layer 50B provided on the second end surface LS2 in the length direction L is, for example, preferably between about 2 μm and about 220 μm inclusive in the middle of the second base electrode layer 50B in the lamination direction T and the width direction W.

In cases where the first base electrode layer 50A is also provided on a portion of at least one of the first main surface TS1 or the second main surface TS2, the thickness of the first base electrode layer 50A provided in this portion in the lamination direction T is, for example, preferably between about 3 μm and about 40 μm inclusive in the middle of the first base electrode layer 50A provided in this portion in the length direction L and the width direction W.

In cases where the first base electrode layer 50A is also provided on a portion of at least one of the first lateral surface WS1 or the second lateral surface WS2, the thickness of the first base electrode layer 50A provided in this portion in the width direction W is, for example, preferably between about 3 μm and about 40 μm inclusive in the middle of the first base electrode layer 50A provided in this portion in the length direction L and the lamination direction T.

In cases where the second base electrode layer 50B is also provided on a portion of at least one of the first main surface TS1 or the second main surface TS2, the thickness of the second base electrode layer 50B provided in this portion in the lamination direction T is, for example, preferably between about 3 μm and about 40 μm inclusive in the middle of the second base electrode layer 50B provided in this portion in the length direction L and the width direction W.

In cases where the second base electrode layer 50B is also provided on a portion of at least one of the first lateral surface WS1 or the second lateral surface WS2, the thickness of the second base electrode layer 50B provided in this portion in the width direction W is, for example, preferably between about 3 μm and about 40 μm inclusive in the middle of the second base electrode layer 50B provided in this portion in the length direction L and the lamination direction T.

The first plated layer 60A covers the first base electrode layer 50A.

The second plated layer 60B covers the second base electrode layer 50B.

The first plated layer 60A and the second plated layer 60B may include, for example, at least one of Cu, Ni, Sn, Ag, Pd, Ag—Pd alloy, or Au. The first plated layer 60A and the second plated layer 60B may include a plurality of layers. The first plated layer 60A and the second plated layer 60B preferably include a two-layer configuration in which a Sn plated layer is provided on top of a Ni plated layer.

In the present example embodiment, for example, the first plated layer 60A includes a first Ni plated layer 61A, and a first Sn plated layer 62A on the first Ni plated layer 61A.

In the present example embodiment, for example, the second plated layer 60B includes a second Ni plated layer 61B, and a second Sn plated layer 62B on the second Ni plated layer 61B.

The Ni plated layer prevents the first base electrode layer 50A and the second base electrode layer 50B from being eroded by solder when mounting the multilayer ceramic capacitor 1. The Sn plated layer improves the wettability of solder when mounting the multilayer ceramic capacitor 1. As a result, the multilayer ceramic capacitor 1 can be easily mounted. The thickness of each of the first Ni plated layer 61A, the first Sn plated layer 62A, the second Ni plated layer 61B, and the second Sn plated layer 62B is, for example, preferably between about 1 μm and about 15 μm inclusive.

The external electrodes 40 of the present example embodiment may include an electrically conductive resin layer including electrically conductive particles and thermosetting resin. The electrically conductive resin layer may be provided to cover the fired layer. In the case where the electrically conductive resin layer covers the fired layer, the electrically conductive resin layer is provided between the fired layer and the plated layers (the first plated layer 60A, the second plated layer 60B). The electrically conductive resin layer may completely cover the fired layer or partially cover the fired layer.

An electrically conductive resin layer including thermosetting resin is more flexible than an electrically conductive layer including a plating film or a fired electrically conductive paste. Therefore, the electrically conductive resin layer defines and functions as a cushioning layer, even if the multilayer ceramic capacitor 1 is subjected to physical shock or thermal-cycling shock. Therefore, the electrically conductive resin layer reduces or prevents the occurrence of cracks in the multilayer ceramic capacitor 1.

The metals defining the electrically conductive particles may be, for example, Ag, Cu, Ni, Sn, Bi, or alloys including them. The electrically conductive particles preferably include, for example, Ag (silver). The electrically conductive particles are, for example, metallic powder of Ag. Ag has the lowest specific resistance among metals, thus suitable as an electrode material. Ag being a noble metal is resistant to oxidation and has high weather resistance. Therefore, metallic powder of Ag is suitable as conductive particles.

The electrically conductive particles may be, for example, metal powders coated with Ag on the surfaces thereof. When using a metal powder coated with Ag, the metal powder is, for example, preferably Cu, Ni, Sn, Bi, or their alloy powder. Ag-coated metal powders are preferably used in order to maintain the properties of Ag while controlling the cost of the base metal.

The electrically conductive particles may be, for example, Cu or Ni subjected to antioxidant treatment. The electrically conductive particles may be, for example, metal powder coated with Sn, Ni, Cu on the surfaces thereof. When using metal powder coated with Sn, Ni, Cu, the metal powder is, for example, preferably Ag, Cu, Ni, Sn, Bi, or their alloy powders.

The shape of the electrically conductive particles is not particularly limited. Electrically conductive particles can be of various shapes, including spherical and flat shapes, but it is preferable to use a mixture of spherical metal powders and flat metal powders.

The electrically conductive particles included in the electrically conductive resin layer primarily ensures the electric conductivity of the electrically conductive resin layer. Specifically, a plurality of electrically conductive particles contacting each other provide electrically conductive pathways within the electrically conductive resin layer.

The resin of the electrically conductive resin layer may include, for example, at least one of various known thermosetting resins, such as epoxy resin, phenolic resin, urethane resin, silicone resin, polyimide resin, among others. Among these, for example, epoxy resin, known for its excellent heat resistance, moisture resistance, and adhesiveness, is one of the most suitable resins. The resin of the electrically conductive resin layer preferably includes a curing agent along with the thermosetting resin. When using epoxy resin as the base resin, the curing agent for epoxy resin may be, for example, one of various known compounds, such as phenolic, amine, anhydride, imidazole, active ester, amid-imide type.

The electrically conductive resin layer may include a plurality of layers. The thickest portion of the electrically conductive resin layer is, for example, preferably between about 10 μm and about 150 μm inclusive.

The basic configuration of the multilayer ceramic capacitor 1 according to the present example embodiment has been described above. The dimension of the multilayer ceramic capacitor 1 including the multilayer body 10 and the external electrodes 40 in the length direction, referred to as the L dimension, is, for example, preferably between about 0.2 mm and about 10 mm inclusive. The dimension of the multilayer ceramic capacitor 1 in the lamination direction, referred to as the T dimension, is, for example, preferably between about 0.1 mm and about 10 mm inclusive. The dimension of the multilayer ceramic capacitor 1 in the width direction, referred to as the W dimension, is, for example, preferably between about 0.1 mm and about 10 mm inclusive.

The multilayer ceramic capacitor 1 of the present example embodiment including the above basic configuration includes the following features in the external electrode 40, that is, the first external electrode 40A and the second external electrode 40B.

As shown in FIG. 2, the first external electrode 40A of the present example embodiment includes the first end surface-side external electrode 400A provided on the first end surface LS1, the first main surface-side external electrode 411A provided on the first main surface TS1, and the second main surface-side external electrode 412A provided on the second main surface TS2. As shown in FIGS. 4A and 4B, the first external electrode 40A of the present example embodiment includes the first lateral surface-side external electrode 421A provided on the first lateral surface WS1, and the second lateral surface-side external electrode 422A provided on the second lateral surface WS2.

As shown in FIG. 2, the first end surface-side external electrode 400A of the first external electrode 40A includes a first end surface-side base electrode layer 500A provided on the first end surface LS1 and a first end surface-side plated layer 600A provided as an upper layer of the first end surface-side base electrode layer 500A. The first end surface-side base electrode layer 500A is a portion of the first base electrode layer 50A. The first end surface-side plated layer 600A is a portion of the first plated layer 60A, and includes a first Ni plated layer 61A and a first Sn plated layer 62A on the first Ni plated layer 61A.

As shown in FIG. 2, the first main surface-side external electrode 411A of the first external electrode 40A includes a first main surface-side base electrode layer 511A provided on the first main surface TS1 and a first main surface-side plated layer 611A provided as an upper layer of the first main surface-side base electrode layer 511A. The first main surface-side base electrode layer 511A is a portion of the first base electrode layer 50A. The first main surface-side plated layer 611A is a portion of the first plated layer 60A, and includes a first Ni plated layer 61A and a first Sn plated layer 62A on the first Ni plated layer 61A.

As shown in FIG. 2, the second main surface-side external electrode 412A of the first external electrode 40A includes a second main surface-side base electrode layer 512A provided on the second main surface TS2, and a second main surface-side plated layer 612A provided as an upper layer of the second main surface-side base electrode layer 512A. The second main surface-side base electrode layer 512A is a portion of the first base electrode layer 50A. The second main surface-side plated layer 612A is a portion of the first plated layer 60A, and includes a first Ni plated layer 61A and a first Sn plated layer 62A on the first Ni plated layer 61A.

As shown in FIGS. 4A and 4B, the first lateral surface-side external electrode 421A of the first external electrode 40A includes a first lateral surface-side base electrode layer 521A provided on the first lateral surface WS1, and a first lateral surface-side plated layer 621A provided as an upper layer of the first lateral surface-side base electrode layer 521A. The first lateral surface-side base electrode layer 521A is a portion of the first base electrode layer 50A. The first lateral surface-side plated layer 621A is a portion of the first plated layer 60A, and includes a first Ni plated layer 61A and a first Sn plated layer 62A on the first Ni plated layer 61A.

As shown in FIGS. 4A and 4B, the second lateral surface-side external electrode 422A of the first external electrode 40A includes a second lateral surface-side base electrode layer 522A provided on the second lateral surface WS2, and a second lateral surface-side plated layer 622A provided as an upper layer of the second lateral surface-side base electrode layer 522A. The second lateral surface-side base electrode layer 522A is a portion of the first base electrode layer 50A. The second lateral surface-side plated layer 622A is a portion of the first plated layer 60A, and includes a first Ni plated layer 61A and a first Sn plated layer 62A on the first Ni plated layer 61A.

As shown in FIG. 2, the second external electrode 40B of the present example embodiment includes a second end surface-side external electrode 400B provided on the second end surface LS2, a third main surface-side external electrode 411B provided on the first main surface TS1, and a fourth main surface-side external electrode 412B provided on the second main surface TS2. As shown in FIGS. 4A and 4B, the second external electrode 40B of the present example embodiment further includes a third lateral surface-side external electrode 421B provided on the first lateral surface WS1, and a fourth lateral surface-side external electrode 422B provided on the second lateral surface WS2.

As shown in FIG. 2, the second end surface-side external electrode 400B of the second external electrode 40B includes a second end surface-side base electrode layer 500B provided on the second end surface LS2, and a second end surface-side plated layer 600B provided as an upper layer of the second end surface-side base electrode layer 500B. The second end surface-side base electrode layer 500B is a portion of the second base electrode layer 50B. The second end surface-side plated layer 600B is a portion of the second plated layer 60B, and includes a second Ni plated layer 61B and a second Sn plated layer 62B on the second Ni plated layer 61B.

As shown in FIG. 2, the third main surface-side external electrode 411B of the second external electrode 40B includes a third main surface-side base electrode layer 511B provided on the first main surface TS1 and a third main surface-side plated layer 611B provided as an upper layer of the third main surface-side base electrode layer 511B. The third main surface-side base electrode layer 511B is a portion of the second base electrode layer 50B. The third main surface-side plated layer 611B is a portion of the second plated layer 60B, and includes a second Ni plated layer 61B and a second Sn plated layer 62B on the second Ni plated layer 61B.

As shown in FIG. 2, the fourth main surface-side external electrode 412B of the second external electrode 40B includes a fourth main surface-side base electrode layer 512B provided on the second main surface TS2, and a fourth main surface-side plated layer 612B provided as an upper layer of the fourth main surface-side base electrode layer 512B. The fourth main surface-side base electrode layer 512B is a portion of the second base electrode layer 50B. The fourth main surface-side plated layer 612B is a portion of the second plated layer 60B, and includes a second Ni plated layer 61B and a second Sn plated layer 62B on the second Ni plated layer 61B.

As shown in FIGS. 4A and 4B, the third lateral surface-side external electrode 421B of the second external electrode 40B includes a third lateral surface-side base electrode layer 521B provided on the first lateral surface WS1 and a third lateral surface-side plated layer 621B provided as an upper layer of the third lateral surface-side base electrode layer 521B. The third lateral surface-side base electrode layer 521B is a portion of the second base electrode layer 50B. The third lateral surface-side plated layer 621B is a portion of the second plated layer 60B, and includes a second Ni plated layer 61B and a second Sn plated layer 62B on the second Ni plated layer 61B.

As shown in FIGS. 4A and 4B, the fourth lateral surface-side external electrode 422B of the second external electrode 40B includes a fourth lateral surface-side base electrode layer 522B provided on the second lateral surface WS2, and a fourth lateral surface-side plated layer 622B provided as an upper layer of the fourth lateral surface-side base electrode layer 522B. The fourth lateral surface-side base electrode layer 522B is a portion of the second base electrode layer 50B. The fourth lateral surface-side plated layer 622B is a portion of the second plated layer 60B, and includes a second Ni plated layer 61B and a second Sn plated layer 62B on the second Ni plated layer 61B. The maximum thickness of each of the first main surface-side base electrode layer 511A, the second main surface-side base electrode layer 512A, the third main surface-side base electrode layer 511B, and the fourth main surface-side base electrode layer 512B is not limited, but is preferably, for example, about 15 μm or more and about 40 μm or less.

As shown in FIG. 2, the first main surface-side external electrode 411A of the first external electrode 40A includes a first recess 510A recessed toward the multilayer body 10. The first recess 510A is provided on the surface of the first main surface-side external electrode 411A. The first recess 510A includes a groove shape extending in the width direction W perpendicular or substantially perpendicular to the LT cross section, that is, in the front and back directions of the paper plane of FIG. 2. The first recess 510A is preferably provided over the entire or substantially the entire length of the first main surface-side external electrode 411A along the width direction W. The first recess 510A may be provided in the vicinity of substantially the middle of the first main surface-side external electrode 411A in the length direction L, or may be provided on the inner side or the outer side of the first main surface-side external electrode 411A in the length direction L.

The first recess 510A of the present example embodiment is provided by causing the first main surface-side base electrode layer 511A and the first main surface-side plated layer 611A to sink toward the first main surface TS1 of the multilayer body 10. In the LT cross-sectional view, it is preferable that a bottom portion of the first recess 510A is recessed in an R shape, and edges of both ends thereof in the length direction L, which transition to the surface of the first main surface-side external electrode 411A, are also smoothly formed in an R shape. The depth of the first recess 510A is not limited, but is preferably about 3 μm or more and about 35 μm or less, for example. The depth herein refers to the shortest distance between the deepest portion of the first recess 510A and a line connecting the surfaces of the first main surface-side external electrodes 411A on both sides of the first recess 510A in the length direction L. The width of the first recess 510A (dimension corresponding to the length direction L) is not limited, but is preferably about 50 μm or more and about 400 μm or less, for example.

As shown in FIG. 2, the second main surface-side external electrode 412A of the first external electrode 40A includes a second recess 520A recessed toward the multilayer body 10. The second recess 520A is provided on the surface of the second main surface-side external electrode 412A. The second recess 520A includes a groove shape extending in the width direction W perpendicular or substantially perpendicular to the LT cross section, that is, in the front and back directions of the paper plane of FIG. 2. The second recess 520A is preferably provided over the entire or substantially the entire length of the second main surface-side external electrode 412A along the width direction W. The second recess 520A may be provided in the vicinity of substantially the middle of the second main surface-side external electrode 412A in the length direction L, or may be provided on the inner side or the outer side of the second main surface-side external electrode 412A in the length direction L.

The second recess 520A of the present example embodiment is provided by causing the second main surface-side base electrode layer 512A and the second main surface-side plated layer 612A to sink toward the second main surface TS2 side of the multilayer body 10. In the LT cross-sectional view, it is preferable that the bottom portion of the second recess 520A is recessed in an R shape, and the edges of both ends thereof in the length direction L, which transition to the surface of the second main surface-side external electrode 412A, are also smoothly formed in an R shape. The depth of the second recess 520A is not limited, but is preferably about 3 μm or more and about 35 μm or less, for example. The depth herein refers to the shortest distance between the deepest portion of the second recess 520A and a line connecting the surfaces of the second main surface-side external electrodes 412A on both sides of the second recess 520A in the length direction L. The width of the second recess 520A (dimension corresponding to the length direction L) is not limited, but is preferably about 50 μm or more and about 400 μm or less, for example.

As shown in FIG. 2, the third main surface-side external electrode 411B of the second external electrode 40B includes a third recess 530B recessed toward the multilayer body 10. The third recess 530B is provided on the surface of the third main surface-side external electrode 411B. The third recess 530B includes a groove shape extending in the width direction W perpendicular or substantially perpendicular to the LT cross section, that is, in the front and back directions of the paper plane of FIG. 2. The third recess 530B is preferably provided over the entire or substantially the entire length of the third main surface-side external electrode 411B along the width direction W. The third recess 530B may be provided in the vicinity of the substantially middle of the third main surface-side external electrode 411B in the length direction L, or may be provided on the inner side or the outer side of the third main surface-side external electrode 411B in the length direction L.

The third recess 530B of the present example embodiment is provided by causing the third main surface-side base electrode layer 511B and the third main surface-side plated layer 611B to sink toward the first main surface TS1 of the multilayer body 10. In the LT cross-sectional view, it is preferable that a bottom portion of the third recess 530B is recessed in an R shape, and edges of both ends thereof in the length direction L, which transition to the surface of the third main surface-side external electrode 411B, are also smoothly formed in an R shape. The depth of the third recess 530B is not limited, but is preferably about 3 μm or more and about 35 μm or less, for example. The depth herein refers to the shortest distance between the deepest portion of the third recess 530B and a line connecting the surfaces of the third main surface-side external electrodes 411B on both sides of the third recess 530B in the length direction L. The width of the third recess 530B (dimension corresponding to the length direction L) is not limited, but is preferably about 50 μm or more and about 400 μm or less, for example.

As shown in FIG. 2, the fourth main surface-side external electrode 412B of the second external electrode 40B includes a fourth recess 540B recessed toward the multilayer body 10. The fourth recess 540B is provided on the surface of the fourth main surface-side external electrode 412B. The fourth recess 540B includes a groove shape extending in the width direction W perpendicular or substantially perpendicular to the LT cross section, that is, in the front and back directions of the paper plane of FIG. 2. The fourth recess 540B is preferably provided over the entire or substantially the entire length of the fourth main surface-side external electrode 412B along the width direction W. The fourth recess 540B may be provided in the vicinity of substantially the middle of the fourth main surface-side external electrode 412B in the length direction L, or may be provided on the inner side or the outer side of the fourth main surface-side external electrode 412B in the length direction L. The fourth recess 540B of the present example embodiment is provided by causing the fourth main surface-side base electrode layer 512B and the fourth main surface-side plated layer 612B to sink toward the second main surface TS2 side of the multilayer body 10. In the LT cross-sectional view, it is preferable that a bottom portion of the fourth recess 540B is recessed in an R shape, and edges of both ends thereof in the length direction L, which transition to the surface of the fourth main surface-side external electrode 412B, are also smoothly formed in an R shape. The depth of the fourth recess 540B is not limited, but is preferably about 3 μm or more and about 35 μm or less, for example. The depth herein refers to the shortest distance between the deepest portion of the fourth recess 540B and a line connecting the surfaces of the fourth main surface-side external electrodes 412B on both sides of the fourth recess 540B in the length direction L. The width of the fourth recess 540B (dimension corresponding to the length direction L) is not limited, but is preferably about 50 μm or more and about 400 μm or less, for example.

The depth of the first recess 510A is not limited, but is, for example, preferably about 10% or more and about 80% or less of the maximum thickness in the thickness corresponding to the lamination direction T of the first main surface-side external electrode 411A, and may be, for example, about 40% or more and about 80% or less, or may be about 60% or more and about 80% or less. The depth of the second recess 520A is not limited, but is, for example, preferably about 10% or more and about 80% or less of the maximum thickness of the thickness corresponding to the lamination direction T of the second main surface-side external electrode 412A, and may be, for example, about 40% or more and about 80% or less, or may be about 60% or more and about 80% or less. The depth of the third recess 530B is not limited, but is, for example, preferably about 10% or more and about 80% or less of the maximum thickness of the thickness corresponding to the lamination direction T of the third main surface-side external electrode 411B, and may be, for example, about 40% or more and about 80% or less, or may be about 60% or more and about 80% or less. The depth of the fourth recess 540B is not limited, but is, for example, preferably about 10% or more and about 80% or less of the maximum thickness of the thickness corresponding to the lamination direction T of the fourth main surface-side external electrode 412B, and may be, for example, about 40% or more and about 80% or less, or may be about 60% or more and about 80% or less.

Here, in FIG. 2 showing the LT cross section of the multilayer ceramic capacitor 1, a first virtual line 100 and a second virtual line 200 are shown. The first virtual line 100 is a virtual line connecting the first recess 510A and the fourth recess 540B in the LT cross-sectional view of the multilayer ceramic capacitor 1. The first virtual line 100 connects the deepest portion of the first recess 510A and the deepest portion of the fourth recess 540B. The second virtual line 200 is a virtual line connecting the second recess 520A and the third recess 530B in the LT cross-sectional view of the multilayer ceramic capacitor 1. The second virtual line 200 connects the deepest portion of the second recess 520A and the deepest portion of the third recess 530B. Further, FIG. 2 shows an intersection 300 of the first virtual line 100 and the second virtual line 200.

In the present example embodiment, the intersection 300 of the first virtual line 100 and the second virtual line 200 is located between the first capacitor portion CAP1 and the second capacitor portion CAP2 in the length direction L. The intersection 300 of the first virtual line 100 and the second virtual line 200 is located in the series connection region (intermediate gap) described above.

In the present example embodiment, the first virtual line 100 intersects the portion 1a of the first capacitor portion CAP1 adjacent to the second end surface LS2, and intersects the portion 2a of the second capacitor portion CAP2 adjacent to the first end surface LS1.

In the present example embodiment, the second virtual line 200 intersects the portion 1a of the first capacitor portion CAP1 adjacent to the second end surface LS2, and intersects the portion 2a of the second capacitor portion CAP2 adjacent to the first end surface LS1.

In the multilayer ceramic capacitor 1 of the present example embodiment, the external electrodes 40, that is, the first external electrode 40A and the second external electrode 40B both have tensile stress as residual stress. This tensile stress is generated by shrinkage or the like of the fired layers (the first base electrode layer 50A and the second base electrode layer 50B) of the external electrode 40 provided on the surface of the multilayer body 10 during cooling, and acts from the main surface-side external electrode toward the center of the end surface-side external electrode, for example.

The tensile stress as the residual stress of the first external electrode 40A and the second external electrode 40B is, for example, about 10 MPa or more, or about 50 MPa or more.

Examples of a method of measuring the depth and the width of each recess described above include, for example, the following method. The multilayer ceramic capacitor 1 is polished from the first lateral surface WS1 or the second lateral surface WS2 to a position of approximately one half of the dimension in the width direction W. As a result, the LT cross section at the middle position in the width direction W of the multilayer ceramic capacitor 1 is exposed. Next, the depth and width of the recess in the LT cross section exposed by polishing are measured using a digital microscope. Thus, the depth and width of each recess are measured.

As described above, in the multilayer ceramic capacitor 1 of the present example embodiment, the first external electrode 40A and the second external electrode 40B have tensile stress. The tensile stress can be measured by the following method. First, the multilayer ceramic capacitor 1 is immersed in a solution for a predetermined period of time using a metal stripping agent for Sn stripping, and then washed with water to strip the Sn plated layer. Next, the multilayer ceramic capacitor 1 is immersed in the solution for a predetermined period of time using a metal stripping agent for Ni stripping, and then washed with water to strip the Ni plated layer. Thereafter, stress is measured using an X-ray diffraction method (μ-XRD (X-ray Diffraction)) on the surfaces of the base electrode layers located on the first main surface TS1 and the second main surface TS2 of the multilayer ceramic capacitor 1, in the vicinity of the end portions thereof (the end portion 40AE and the end portion 40BE in FIG. 2).

Next, an example of a method of manufacturing the multilayer ceramic capacitor 1 of the present example embodiment will be described. The manufacturing method of the multilayer ceramic capacitor 1 of the present example embodiment is not limited as long as the requirements described above are satisfied. However, an example of a manufacturing method includes the following steps. The details of each step will be described below.

A dielectric sheet for manufacturing the dielectric layer 20 and an electrically conductive paste for manufacturing the internal electrode layer 30 are prepared. The dielectric sheet and the electrically conductive paste for manufacturing the internal electrode include a binder and a solvent. The binder and the solvent may be known.

An electrically conductive paste for manufacturing the internal electrode layer 30 is printed on the dielectric sheet in a predetermined pattern by, for example, screen printing or gravure printing. As a result, a dielectric sheet with a pattern of the first internal electrode layer 31, a dielectric sheet with a pattern of the second internal electrode layer 32, and a dielectric sheet with a pattern of the intermediate electrode layer 33 are prepared.

By a predetermined number of dielectric sheets on which the pattern of the internal electrode layer 30 is not printed being laminated, a portion defining and functioning as the first main surface-side outer layer portion 12 adjacent to the first main surface TS1 is formed. On the portion defining and functioning as the first main surface-side outer layer portion 12, dielectric sheets on which the pattern of the first internal electrode layer 31 and the pattern of the second internal electrode layer 32 are formed, and dielectric sheets on which the pattern of the intermediate electrode layer 33 is formed are sequentially and alternately laminated. Thus, a portion defining and functioning as the inner layer portion 11 is formed. On the portion defining and functioning as the inner layer portion 11, a predetermined number of dielectric sheets on which the pattern of the internal electrode layer 30 is not printed are laminated, such that a portion defining and functioning as the second main surface-side outer layer portion 13 adjacent to the second main surface TS2 is formed. This produces a multilayer sheet.

The multilayer sheet is pressed in the height direction by, for example, isostatic pressing to produce a multilayer block.

The multilayer block is cut into a plurality of multilayer chips of a predetermined size. In this case, the multilayer chips may be polished, for example, by barrel polishing, to round the corner portions and edge portions.

The multilayer chips are fired to produce the multilayer body 10. The firing temperature is, for example, preferably between about 900° C. and about 1400° C. inclusive, depending on the materials of the dielectric layer 20 and the internal electrode layer 30.

An electrically conductive paste, which will define and function as the base electrode layers, is applied to both end surfaces of the multilayer body 10.

In the present example embodiment, the base electrode layer is a fired layer. The electrically conductive paste including glass components and metal is applied to the multilayer body 10, for example, by dipping. Subsequently, the base electrode layer is formed through firing processing. The firing temperature in this case is, for example, preferably between about 700° C. and about 900° C. inclusive.

In the cases of simultaneously firing the pre-firing multilayer chip and the electrically conductive paste applied to the multilayer chips, the fired layer is preferably formed by firing a material including a ceramic material instead of glass components. In this case, as the ceramic material to be added, a ceramic material of the same type as the dielectric layer 20 is preferably used. In this case, an electrically conductive paste is applied to the pre-firing multilayer chips, and the multilayer chips as well as the electrically conductive paste applied to the multilayer chips are simultaneously fired, thus forming the multilayer body 10 with the fired layers.

Subsequently, a plated layer is formed on the surface of the base electrode layers. In the present example embodiment, the first plated layer 60A is formed on the surface of the first base electrode layer 50A. The second plated layer 60B is formed on the surface of the second base electrode layer 50B. In the present example embodiment, for example, a Ni plated layer and a Sn plated layer are formed as the plated layers. For the plating processing, either electrolytic plating or electroless plating may be used.

However, electroless plating requires pretreatment with catalysts to improve the plating deposition rate, involving a drawback to increase the complexity of the steps. Therefore, electrolytic plating is preferred in most cases. The Ni plated layer and the Sn plated layer are sequentially formed, for example, by barrel plating.

The electrically conductive resin layer, when provided as the base electrode layer, may be provided to cover the fired layer. In the case of providing an electrically conductive resin layer, an electrically conductive resin paste including thermosetting resin and metal components is applied onto the fired layer, followed by heat treatment at temperature ranging from about 250° C. to about 550° C. or higher, for example. This processing causes the thermosetting resin to cure, forming the electrically conductive resin layer. The atmosphere during this heat treatment is, for example, preferably an N₂ environment. The oxygen concentration is, for example, preferably about 100 ppm or lower in order to prevent the resin from dispersing and prevent the various metal components from oxidating.

Here, in order to obtain the recess including the groove shape described above at each main surface-side external electrode of the external electrode 40 as in the example embodiments, for example, the following method is used.

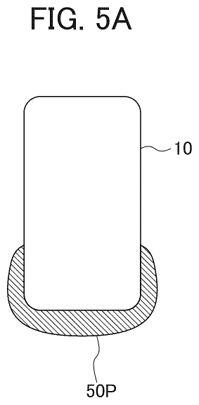

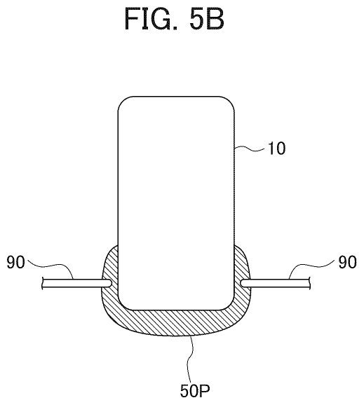

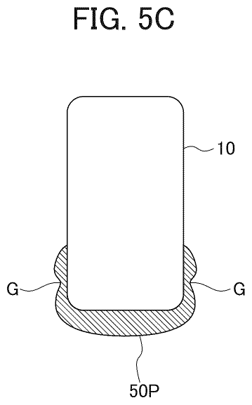

FIGS. 5A to 5C each schematically show a step of forming a base electrode layer (the first base electrode layer 50A and the second base electrode layer 50B) in the example method. As shown in FIG. 5A, a base electrode paste 50P defining and functioning as a base electrode layer is applied to an end portion of the multilayer body 10 in the length direction L by dipping. Next, as shown in FIG. 5B, the multilayer body 10 is relatively passed between a pair of rod-shaped jigs 90 opposed to each other. Here, the passing direction is the front-rear direction of the paper plane of FIG. 5B. As a result, as shown in FIG. 5C, groove-shaped recesses G are formed on both sides of the base electrode paste 50P by the tips of the pair of rod-shaped jigs 90. The recesses G correspond to the first recess 510A, the second recess 520A, the third recess 530B, and the fourth recess 540B described above. Thereafter, a Ni plated layer and a Sn plated layer are formed on the base electrode layer.

The recesses can also be formed by appropriately adjusting the viscosity of the base electrode paste 50P and designing the dipping method.

Through the above manufacturing steps, the multilayer ceramic capacitor 1 is manufactured.

A multilayer ceramic capacitor 1 according to an example embodiment of the present invention includes a two-portion series structure. In the multilayer ceramic capacitor 1, large electrostriction occurs between the capacitor portions connected in series, and a force (tensile stress) in the lamination direction T from the middle of the multilayer body 10 toward the first main surface TS1 and the second main surface TS2 may be generated inside the multilayer body 10. Further, the external electrode 40 has a tensile stress as a residual stress due to a shrinkage action of the fired layer or the like, and a force (tensile stress) from the middle of the multilayer body 10 toward the end portion of the external electrode 40 may be generated inside the multilayer body 10 due to the tensile stress of the external electrode 40.

FIG. 6 is an LT cross-sectional view schematically showing the multilayer ceramic capacitor 1 for showing the forces described above. In FIG. 6, the arrow K1 indicates the force of a component in the lamination direction T due to electrostriction generated between the first capacitor portion CAP1 and the second capacitor portion CAP2. The force K1 of the component in the lamination direction is a tensile stress from the middle of the multilayer body 10 toward the first main surface TS1 and the second main surface TS2. In FIG. 6, the forces from the middle of the multilayer body 10 toward the end portions of the first external electrode 40A and the second external electrode 40B due to the residual stress of the external electrode 40 are respectively indicated by arrows K2. The residual stress of the external electrode 40 is indicated by arrows K3 inside each of the first external electrode 40A and the second external electrode 40B. As described above, each of the residual stresses K3 in the external electrode 40 is a tensile stress generated by shrinkage or the like of the fired layers (the first base electrode layer 50A and the second base electrode layer 50B) of the external electrode 40 provided on the surface of the multilayer body 10 during cooling. In the first external electrode 40A, the residual stress in the external electrode 40 acts from the first main surface-side external electrode 411A and the second main surface-side external electrode 412A toward the center of the first end surface-side external electrode 400A. In the second external electrode 40B, the residual stress in the external electrode 40 acts from the third main surface-side external electrode 411B and the fourth main surface-side external electrode 412B toward the center of the second end surface-side external electrode 400B. Further, in FIG. 6, the force of the component in the lamination direction among the forces K2 from the middle of the multilayer body 10 toward the end portion of the external electrode 40 due to the residual stress of the external electrode 40 is indicated by broken line arrows K4.

Here, when the force K1 of the component in the lamination direction due to electrostriction and the force K4 of the component in the lamination direction among the forces K2 from the middle of the multilayer body 10 toward the end portion of the external electrode 40 due to the residual stress of the external electrode 40 are combined, and the force of the combined component in the lamination direction increases, there is a possibility that delamination occurs in the multilayer body 10. However, as in the multilayer ceramic capacitor 1 of the present example embodiment, since each of the main surface-side external electrodes includes the recess, the residual stress in the external electrode 40 from the main surface-side external electrode toward the end-surface-side external electrode is partially divided by the recess, and the force thereof is reduced.

Specifically, the residual stress K3 in the first external electrode 40A from the first main surface-side external electrode 411A toward the first end surface-side external electrode 400A is partially divided by the first recess 510A, and the force thereof is reduced. The residual stress K3 in the first external electrode 40A from the second main surface-side external electrode 412A toward the first end-surface-side external electrode 400A is partially divided by the second recess 520A, and the force thereof is reduced. The residual stress K3 in the second external electrode 40B from the third main surface-side external electrode 411B toward the second end surface-side external electrode 400B is partially divided by the third recess 530B, and the force thereof is reduced. The residual stress K3 in the second external electrode 40B from the fourth main surface-side external electrode 412B toward the second end surface-side external electrode 400B is divided by the fourth recess 540B, and the force thereof is reduced.

For this reason, the force K2 directed from the middle of the multilayer body 10 toward the end portion of the external electrode 40 is reduced by the residual stress of the external electrode 40, and the force that causes delamination, that is, the force K4 of the above-described component in the lamination direction, is reduced. With such a configuration, it is possible to reduce or prevent the occurrence of delamination.

The multilayer ceramic capacitor 1 according to the above example embodiments achieves the following advantageous effects.

(1) A multilayer ceramic capacitor 1 according to an example embodiment of the present invention includes the multilayer body 10 including the plurality of dielectric layers 20 and the plurality of internal electrode layers 30 that are alternately laminated in the lamination direction T, the first main surface TS1 and the second main surface TS2 opposed to each other in the lamination direction T, the first lateral surface WS1 and the second lateral surface WS2 opposed to each other in the width direction W orthogonal or substantially orthogonal to the lamination direction T, and the first end surface LS1 and the second end surface LS2 opposed to each other in the length direction L orthogonal or substantially orthogonal to the lamination direction T and the width direction W, and the pair of external electrodes 40 each on one of two end portions of the multilayer body 10 in the length direction L, and being spaced apart from each other. The plurality of internal electrode layers 30 include the plurality of first internal electrode layers 31 that extend toward and are exposed at the first end surface LS1, the plurality of second internal electrode layers 32 that extend toward and are exposed at the second end surface LS2, and the plurality of intermediate electrode layers 33 that do not extend toward and are not exposed at either of the first end surface LS1 and the second end surface LS2. The multilayer body 10 includes the first capacitor portion CAP1 including the plurality of first internal electrode layers 31 and the plurality of intermediate electrode layers 33 opposed to each other, and the second capacitor portion CAP2 including the plurality of second internal electrode layers 32 and the plurality of intermediate electrode layers 33 opposed to each other. The pair of external electrodes 40 include the first external electrode 40A provided on and adjacent to the first end surface LS1, and the second external electrode 40B provided on and adjacent to the second end surface LS2. The first external electrode 40A includes the first main surface-side external electrode 411A on the first main surface TS1 and the second main surface-side external electrode 412A on the second main surface TS2. The second external electrode 40B includes the third main surface-side external electrode 411B on the first main surface TS1 and the fourth main surface-side external electrode 412B on the second main surface TS2. The first main surface-side external electrode 411A includes the first recess 510A recessed toward the multilayer body 10. The second main surface-side external electrode 412A includes the second recess 520A recessed toward the multilayer body 10. The third main surface-side external electrode 411B includes the third recess 530B recessed toward the multilayer body 10. The fourth main surface-side external electrode 412B includes the fourth recess 540B recessed toward the multilayer body 10. In a cross sectional view along the length direction L and the lamination direction T, the intersection 300 between the first virtual line 100 connecting the first recess 510A and the fourth recess 540B and the second virtual line 200 connecting the second recess 520A and the third recess 530B is located between the first capacitor portion CAP1 and the second capacitor portion CAP2 in the length direction L. The pair of external electrodes 40 each have a tensile stress as a residual stress.

With such a configuration, in the multilayer ceramic capacitor 1 of high breakdown voltage specification, it is possible to reduce or prevent the occurrence of delamination in the multilayer body 10.

(2) In a multilayer ceramic capacitor 1 according to an example embodiment of the present invention, the first virtual line 100 intersects the portion 1a of the first capacitor portion CAP1 adjacent to the second end surface LS2, and intersects the portion 2a of the second capacitor portion CAP2 adjacent to the first end surface LS1, and the second virtual line 200 intersects the portion 1a of the first capacitor portion CAP1 adjacent to the second end surface LS2, and intersects the portion 2a of the second capacitor portion CAP2 adjacent to the first end surface LS1.

With such a configuration, in the multilayer ceramic capacitor 1 of high breakdown voltage specification, it is possible to reduce or prevent the occurrence of delamination in the multilayer body 10.

The present invention is not limited to the two-portion multilayer ceramic capacitor 1 according to the above-described example embodiment, and can be widely applied to a multilayer ceramic capacitor including a series structure. Hereinafter, a first modification including a three-portion configuration and a second modification including a four-portion configuration will be described.

### First Modification

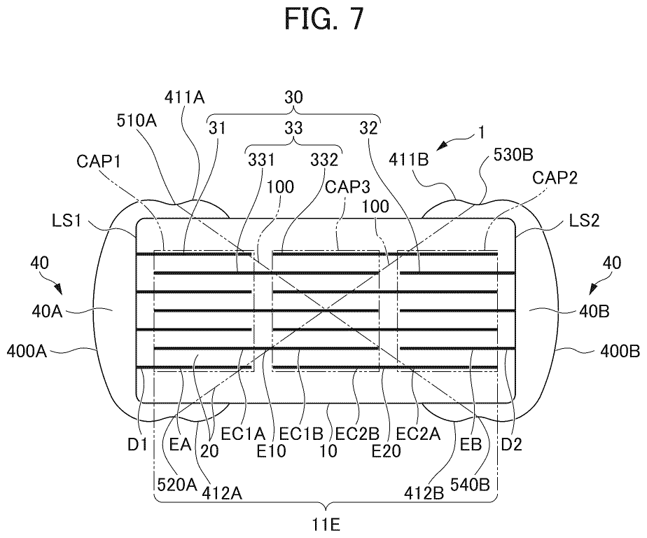

A multilayer ceramic capacitor 1 according to a first modification of an example embodiment of the present invention is a three-portion multilayer ceramic capacitor. Hereinafter, the multilayer ceramic capacitor 1 according to the first modification will be described with reference to FIG. 7. In the following description, detailed descriptions of the same or substantially same configurations as those of the above-described example embodiments may be omitted. FIG. 7 is an LT cross-sectional view schematically showing the multilayer ceramic capacitor 1 according to the first modification. The manufacturing method of the first modification may be the same or substantially same as those of the above-described example embodiments, and a description thereof will be omitted.

In the multilayer ceramic capacitor 1 of the first modification, the plurality of internal electrode layers 30 include a plurality of first internal electrode layers 31, a plurality of second internal electrode layers 32, and a plurality of intermediate electrode layers 33.

As shown in FIG. 7, the plurality of intermediate electrode layers 33 according to the first modification include first intermediate electrode layers 331 and second intermediate electrode layers 332.

The first intermediate electrode layer 331 includes a first electrode layer-side counter portion EC1A, a first intermediate electrode layer counter portion EC1B, and a first coupling portion E10. The first electrode layer-side counter portion EC1A is a region opposed to the first internal electrode layer 31 adjacent in the lamination direction T, provided inside the multilayer body 10. The first intermediate electrode layer counter portion EC1B is a region opposed to the second intermediate electrode layer 332 adjacent in the lamination direction T, provided inside the multilayer body 10. The first coupling portion E10 is a portion connecting the first electrode layer-side counter portion EC1A and the first intermediate electrode layer counter portion EC1B with each other, and is provided between the first electrode layer-side counter portion EC1A and the first intermediate electrode layer counter portion EC1B.

The second intermediate electrode layer 332 includes a second electrode layer-side counter portion EC2A, a second intermediate electrode layer counter portion EC2B, and a second coupling portion E20. The second electrode layer-side counter portion EC2A is opposed to the second internal electrode layer 32 adjacent in the lamination direction T. The second intermediate electrode layer counter portion EC2B is opposed to the first intermediate electrode layer 331 adjacent in the lamination direction T. The second coupling portion E20 is a portion connecting the second electrode layer-side counter portion EC2A and the second intermediate electrode layer counter portion EC2B with each other, and is provided between the second electrode layer-side counter portion EC2A and the second intermediate electrode layer counter portion EC2B.

As shown in FIG. 7, in the multilayer ceramic capacitor 1 according to the first modification, the first internal electrode layer 31 and the second intermediate electrode layer 332 are provided adjacent to each other in the length direction L. In the multilayer ceramic capacitor 1 of the first modification, the second internal electrode layer 32 and the first intermediate electrode layer 331 are provided adjacent to each other in the length direction L.

In the multilayer ceramic capacitor 1 of the first modification, the first internal electrode layer 31 and the second intermediate electrode layer 332 are laminated alternately to overlap the second internal electrode layer 32 and the first intermediate electrode layer 331, sandwiching the dielectric layers 20.

In the first modification, the first counter portion EA and the first electrode layer-side counter portion EC1A are opposed to each other, sandwiching the dielectric layer 20, such that the first capacitor portion CAP1 that generates the capacitance CAP1 is provided. The second counter portion EB and the second electrode layer-side counter portion EC2A are opposed to each other, sandwiching the dielectric layer, such that the second capacitor portion CAP2 that generates the capacitance CAP2 is provided. The first intermediate electrode layer counter portion EC1B and the second intermediate electrode layer counter portion EC2B are opposed to each other, sandwiching the dielectric layer 20, such that the third capacitor portion CAP3 that generates the capacitance CAP3 is provided. The first coupling portion E10 connects the first capacitor portion CAP1 and the third capacitor portion CAP3 in series. The second coupling portion E20 connects the second capacitor portion CAP2 and the third capacitor portion CAP3 in series. The multilayer ceramic capacitor 1 of the first modification is a three-portion series-configured multilayer ceramic capacitor 1, in which three series-connected capacitor portions (the first capacitor portion CAP1, the second capacitor portion CAP2, and the third capacitor portion CAP3) are provided.

The multilayer body 10 includes a series capacitor forming portion 11E. The series capacitor forming portion 11E includes a first capacitor portion CAP1, a second capacitor portion CAP2, a third capacitor portion CAP3, a portion connecting the first capacitor portion CAP1 and the third capacitor portion CAP3 in series, and a portion connecting the second capacitor portion CAP2 and the third capacitor portion CAP3 in series. The series capacitor forming portion 11E is configured as a portion of the inner layer portion 11. In the series capacitor forming portion 11E, the first capacitor portion CAP1, the second capacitor portion CAP2, and the third capacitor portion CAP3 are also referred to as capacitor effective portions.

The series capacitor forming portion 11E of the multilayer body 10 includes the first series connection region and the second series connection region. The first series connection region is a portion which includes the dielectric layer 20 and the first coupling portion E10, and is located between the first capacitor portion CAP1 and the third capacitor portion CAP3. The second series connection region is a portion which includes the dielectric layer 20 and the second coupling portion E20, and is located between the second capacitor portion CAP2 and the third capacitor portion CAP3. That is, the first series connection region is a collective portion including a portion of the plurality of dielectric layers 20 overlapping the first coupling portion E10 as viewed from the lamination direction T, and the plurality of first coupling portions E10. The second series connection region is a collective portion including a portion of the plurality of dielectric layers 20 overlapping the second coupling portion E20 as viewed from the lamination direction T, and the plurality of second coupling portions E20.

As shown in FIG. 7, the external electrodes 40 include the first external electrode 40A on and adjacent to the first end surface LS1 of the multilayer body 10, and the second external electrode 40B on and adjacent to the second end surface LS2 of the multilayer body 10.

The first coupling portion E10 connects the first capacitor portion CAP1 and the third capacitor portion CAP3 in series. The second coupling portion E20 connects the second capacitor portion CAP2 and the third capacitor portion CAP3 in series. Therefore, capacitor characteristics of the series-connected capacitance are generated between the first external electrode 40A connected to the first internal electrode layer 31 and the second external electrode 40B connected to the second internal electrode layer 32.

In the multilayer ceramic capacitor 1 according to the first modification, as in the above-described example embodiments, each of the main surface-side external electrodes includes a groove-shaped recess recessed toward the multilayer body 10. That is, in the first external electrode 40A, the first main surface-side external electrode 411A includes a first recess 510A, and the second main surface-side external electrode 412A includes a second recess 520A. In the second external electrode 40B, the third main surface-side external electrode 411B includes a third recess 530B, and the fourth main surface-side external electrode 412B includes a fourth recess 540B. As shown in FIG. 7, in the LT cross-sectional view, an intersection 300 of a first virtual line 100 connecting the first recess 510A and the fourth recess 540B and a second virtual line 200 connecting the second recess 520A and the third recess 530B is located between the first capacitor portion CAP1 and the second capacitor portion CAP2 in the length direction L. In the multilayer ceramic capacitor 1 of the first modification, as in the above-described example embodiments, the external electrodes 40, that is, the first external electrode 40A and the second external electrode 40B, both have tensile stress as residual stress.

(3) In the multilayer ceramic capacitor 1 as described in the first modification, the plurality of intermediate electrode layers 33 include the plurality of first intermediate electrode layers 331 and the plurality of second intermediate electrode layers 332, the plurality of first intermediate electrode layers 331 each include the first electrode layer-side counter portion ECA opposed to the plurality of first internal electrode layers 31 adjacent to each other in the lamination direction T, and the first intermediate electrode layer counter portion EC1B opposed to the plurality of second intermediate electrode layers 332 adjacent to each other in the lamination direction T, and the plurality of second intermediate electrode layers 332 each include the second electrode layer-side counter portion ECB opposed to the plurality of second internal electrode layers 32 adjacent to each other in the lamination direction T, and the second intermediate electrode layer counter portion EC2B opposed to the plurality of first intermediate electrode layers 331 adjacent to each other in the lamination direction T.

Also in the three-portion multilayer ceramic capacitor 1 with such a high breakdown voltage specification, it is possible to reduce or prevent the occurrence of delamination in the multilayer body 10.

### Second Modification

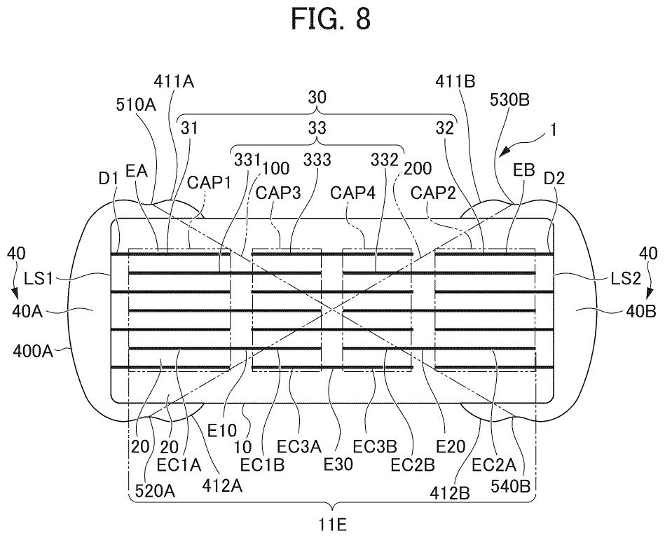

A multilayer ceramic capacitor 1 according to a second modification of an example embodiment of the present invention is a four-portion multilayer ceramic capacitor. Hereinafter, a multilayer ceramic capacitor 1 according to a second modification will be described with reference to FIG. 8. In the following description, detailed descriptions of the same or substantially same configurations as those of the above-described example embodiments and the first modification will be omitted. FIG. 8 is an LT cross-sectional view schematically showing a multilayer ceramic capacitor 1 according to a second modification. The manufacturing method of the second modification may be the same or substantially same as those of the above-described example embodiments, and a description thereof will be omitted.

In the multilayer ceramic capacitor 1 of the second modification, the plurality of internal electrode layers 30 include a plurality of first internal electrode layers 31, a plurality of second internal electrode layers 32, and a plurality of intermediate electrode layers 33.

As shown in FIG. 8, the intermediate electrode layer 33 includes a first intermediate electrode layer 331, a second intermediate electrode layer 332, and a third intermediate electrode layer 333.

Each of the plurality of first intermediate electrode layers 331 includes a first electrode layer-side counter portion EC1A opposed to the first internal electrode layer 31 provided adjacent to each other in the lamination direction T, a first intermediate electrode layer counter portion EC1B opposed to the third intermediate electrode layer 333 provided adjacent to each other in the lamination direction T, and a first coupling portion E10.

The second intermediate electrode layer 332 includes a second electrode layer-side counter portion EC2A opposed to the second internal electrode layer 32 provided adjacent to each other in the lamination direction T, a second intermediate electrode layer counter portion EC2B opposed to the third intermediate electrode layer 333 provided adjacent to each other in the lamination direction T, and a second coupling portion E20.

The third intermediate electrode layer 333 includes a third intermediate electrode layer counter portion EC3A opposed to the first intermediate electrode layer 331 provided adjacent to each other in the lamination direction T, a fourth intermediate electrode layer counter portion EC3B opposed to the second intermediate electrode layer 332 provided adjacent to each other in the lamination direction T, and a third coupling portion E30. As shown in FIG. 8, in the multilayer ceramic capacitor 1 according to the second modification, the first internal electrode layer 31, the third intermediate electrode layer 333, and the second internal electrode layer 32 are provided adjacent to each other in the length direction L. In the multilayer ceramic capacitor 1 according to the second modification, the first intermediate electrode layer 331 and the second intermediate electrode layer 332 are provided so as to be adjacent to each other in the length direction L.

In the multilayer ceramic capacitor 1 according to the second modification, the first internal electrode layer 31, the third intermediate electrode layer 333, and the second internal electrode layer 32 are laminated to alternately overlap the first intermediate electrode layer 331 and the second intermediate electrode layer 332 with the dielectric layer 20 interposed therebetween.

In the second modification, the first counter portion EA and the first electrode layer-side counter portion EC1A are opposed to each other with the dielectric layer 20 interposed therebetween, such that the first capacitor portion CAP1 that generates the capacitance CAP1 is provided. The second counter portion EB and the second electrode layer-side counter portion EC2A are opposed to each other with the dielectric layer 20 interposed therebetween, such that the second capacitor portion CAP2 that generates the capacitance CAP2 is provided. The first intermediate electrode layer counter portion EC1B and the third intermediate electrode layer counter portion EC3A are opposed to each other with the dielectric layer 20 interposed therebetween, such that the third capacitor portion CAP3 that generates the capacitance CAP3 is provided. The second intermediate electrode layer counter portion EC2B and the fourth intermediate electrode layer counter portion EC3B are opposed to each other with the dielectric layer 20 interposed therebetween, such that the fourth capacitor portion CAP4 that generates the capacitance CAP4 is provided. The first coupling portion E10 connects the first capacitor portion CAP1 and the third capacitor portion CAP3 in series. The second coupling portion E20 connects the second capacitor portion CAP2 and the fourth capacitor portion CAP4 in series. The third coupling portion E30 connects the third capacitor portion CAP3 and the fourth capacitor portion CAP4 in series. The multilayer ceramic capacitor 1 of the second modification is a four-portion series-configured multilayer ceramic capacitor in which four capacitor portions (the first capacitor portion CAP1, the second capacitor portion CAP2, the third capacitor portion CAP3, and the fourth capacitor portion CAP4) connected in series are provided.

The multilayer body 10 includes a series capacitor forming portion 11E. The series capacitor forming portion 11E includes the first capacitor portion CAP1, the second capacitor portion CAP2, the third capacitor portion CAP3, the fourth capacitor portion CAP4, the portion connecting the first capacitor portion CAP1 and the third capacitor portion CAP3 in series, the portion connecting the second capacitor portion CAP2 and the fourth capacitor portion CAP4 in series, and the portion connecting the third capacitor portion CAP3 and the fourth capacitor portion CAP4 in series. The series capacitor forming portion 11E is configured as a portion of the inner layer portion 11. In the series capacitor forming portion 11E, the first capacitor portion CAP1, the second capacitor portion CAP2, the third capacitor portion CAP3, and the fourth capacitor portion CAP4 are also referred to as capacitor effective portions.

The series capacitor forming portion 11E of the multilayer body 10 of the second modification includes a first series connection region, a second series connection region, and a third series connection region. The first series connection region is a portion which includes the dielectric layer 20 and the first coupling portion E10, and is located between the first capacitor portion CAP1 and the third capacitor portion CAP3. The second series connection region is a portion which includes the dielectric layer 20 and the second coupling portion E20, and is located between the second capacitor portion CAP2 and the fourth capacitor portion CAP4. The third series connection region is a portion which includes the dielectric layer 20 and the third coupling portion E30, and is located between the third capacitor portion CAP3 and the fourth capacitor portion CAP4. That is, the first series connection region is a collective portion including a portion of the plurality of dielectric layers 20 overlapping the first coupling portion E10 as viewed from the lamination direction T, and the plurality of first coupling portions E10. The second series connection region is a collective portion including a portion of the plurality of dielectric layers 20 overlapping the second coupling portion E20 as viewed from the lamination direction T, and the plurality of second coupling portions E20. The third series connection region is a collective portion including a portion of the plurality of dielectric layers 20 overlapping the third coupling portion E30 as viewed from the lamination direction T, and the plurality of third coupling portions E30.

As shown in FIG. 8, the external electrode 40 includes the first external electrode 40A provided on and adjacent to the first end surface LS1 of the multilayer body 10, and the second external electrode 40B provided on and adjacent to the second end surface LS2 of the multilayer body 10.

The first coupling portion E10 connects the first capacitor portion CAP1 and the third capacitor portion CAP3 in series. The second coupling portion E20 connects the second capacitor portion CAP2 and the fourth capacitor portion CAP4 in series. The third coupling portion E30 connects the third capacitor portion CAP3 and the fourth capacitor portion CAP4 in series. Therefore, capacitor characteristics of the series-connected capacitance are generated between the first external electrode 40A connected to the first internal electrode layer 31 and the second external electrode 40B connected to the second internal electrode layer 32.

In the multilayer ceramic capacitor 1 according to the second modification, as in the above-described example embodiments and the first modification, each of the main surface-side external electrodes includes a groove-shaped recess recessed toward the multilayer body 10. That is, in the first external electrode 40A, the first main surface-side external electrode 411A includes a first recess 510A, and the second main surface-side external electrode 412A includes a second recess 520A. In the second external electrode 40B, the third main surface-side external electrode 411B includes a third recess 530B, and the fourth main surface-side external electrode 412B includes a fourth recess 540B. As shown in FIG. 8, in the LT cross-sectional view, an intersection 300 of a first virtual line 100 connecting the first recess 510A and the fourth recess 540B and a second virtual line 200 connecting the second recess 520A and the third recess 530B is located between the first capacitor portion CAP1 and the second capacitor portion CAP2 in the length direction L. In the multilayer ceramic capacitor 1 of the second modification, as in the above-described example embodiments, the external electrodes 40, that is, the first external electrode 40A and the second external electrode 40B, both have tensile stress as residual stress.

(4) In the multilayer ceramic capacitor 1 as described in the second modification, the plurality of intermediate electrode layers 33 include the plurality of first intermediate electrode layers 331, the plurality of second intermediate electrode layers 332, and the plurality of third intermediate electrode layers 333. The plurality of first intermediate electrode layers 331 each include the first electrode layer-side counter portion ECA opposed to the plurality of first internal electrode layers 31 adjacent to each other in the lamination direction T, and the first intermediate electrode layer counter portion EC1B opposed to the plurality of third intermediate electrode layers 333 adjacent to each other in the lamination direction T, the plurality of second intermediate electrode layers 332 each include the second electrode layer-side counter portion ECB opposed to the plurality of second internal electrode layers 32 adjacent to each other in the lamination direction T, and the second intermediate electrode layer counter portion EC2B opposed to the plurality of third intermediate electrode layers 333 adjacent to each other in the lamination direction T, and the plurality of third intermediate electrode layers 333 each include the third intermediate electrode layer counter portion EC3A opposed to the plurality of first intermediate electrode layers 331 adjacent to each other in the lamination direction T, and the fourth intermediate electrode layer counter portion EC3B opposed to the plurality of second intermediate electrode layers 332 adjacent to each other in the lamination direction T.

Also in the four-portion multilayer ceramic capacitor 1 with high breakdown voltage specification, it is possible to reduce or prevent the occurrence of delamination in the multilayer body 10.

The present invention is not limited to the configurations of the above-described example embodiments and modifications thereof, and can be appropriately modified and applied without changing the scope of the present invention. In addition, a combination of two or more of the individual configurations described in the above example embodiments and modifications thereof is also included in the present invention.

For example, the multilayer ceramic capacitor 1 may be a two-terminal capacitor including two external electrodes or a multi-terminal capacitor including a large number of external electrodes.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers alternately laminated in a height direction, a first main surface and a second main surface opposed to each other in the height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction; and
a pair of external electrodes each on one of two end portions of the multilayer body in the length direction and spaced apart from each other; wherein
the plurality of internal electrode layers include a plurality of first internal electrode layers extending toward and exposed at the first end surface, a plurality of second internal electrode layers extending toward and exposed at the second end surface, and a plurality of intermediate electrode layers not extending toward and not exposed at either of the first end surface and the second end surface;
the multilayer body includes:
a first capacitor portion including the plurality of first internal electrode layers and the plurality of intermediate electrode layers opposed to each other; and
a second capacitor portion including the plurality of second internal electrode layers and the plurality of intermediate electrode layers opposed to each other;
the pair of external electrodes include:
a first external electrode provided on and adjacent to the first end surface; and
a second external electrode provided on and adjacent to the second end surface;
the first external electrode includes a first main surface-side external electrode on the first main surface and a second main surface-side external electrode on the second main surface;
the second external electrode includes a third main surface-side external electrode on the first main surface and a fourth main surface-side external electrode on the second main surface;
the first main surface-side external electrode includes a first recess recessed toward the multilayer body;
the second main surface-side external electrode includes a second recess recessed toward the multilayer body;
the third main surface-side external electrode includes a third recess recessed toward the multilayer body;
the fourth main surface-side external electrode includes a fourth recess recessed toward the multilayer body;
in a cross sectional view along the length direction and the height direction, an intersection between a first virtual line connecting the first recess and the fourth recess and a second virtual line connecting the second recess and the third recess is located between the first capacitor portion and the second capacitor portion in the length direction; and
the pair of external electrodes each have a tensile stress as a residual stress.

2. The multilayer ceramic capacitor according to claim 1, wherein
the first virtual line intersects a portion of the first capacitor portion adjacent to the second end surface, and intersects a portion of the second capacitor portion adjacent to the first end surface; and
the second virtual line intersects a portion of the first capacitor portion adjacent to the second end surface, and intersects a portion of the second capacitor portion adjacent to the first end surface.

3. The multilayer ceramic capacitor according to claim 1, wherein
the plurality of intermediate electrode layers include a plurality of first intermediate electrode layers and a plurality of second intermediate electrode layers;
the plurality of first intermediate electrode layers each include a first electrode layer-side counter portion opposed to the plurality of first internal electrode layers adjacent to each other in the height direction, and a first intermediate electrode layer counter portion opposed to the plurality of second intermediate electrode layers adjacent to each other in the height direction; and
the plurality of second intermediate electrode layers each include a second electrode layer-side counter portion opposed to the plurality of second internal electrode layers adjacent to each other in the height direction, and a second intermediate electrode layer counter portion opposed to the plurality of first intermediate electrode layers adjacent to each other in the height direction.

4. The multilayer ceramic capacitor according to claim 1, wherein
the plurality of intermediate electrode layers include a plurality of first intermediate electrode layers, a plurality of second intermediate electrode layers, and a plurality of third intermediate electrode layers;
the plurality of first intermediate electrode layers each include a first electrode layer-side counter portion opposed to the plurality of first internal electrode layers adjacent to each other in the height direction, and a first intermediate electrode layer counter portion opposed to the plurality of third intermediate electrode layers adjacent to each other in the height direction;
the plurality of second intermediate electrode layers each include a second electrode layer-side counter portion opposed to the plurality of second internal electrode layers adjacent to each other in the height direction, and a second intermediate electrode layer counter portion opposed to the plurality of third intermediate electrode layers adjacent to each other in the height direction; and
the plurality of third intermediate electrode layers each include a third intermediate electrode layer counter portion opposed to the plurality of first intermediate electrode layers adjacent to each other in the height direction, and a fourth intermediate electrode layer counter portion opposed to the plurality of second intermediate electrode layers adjacent to each other in the height direction.

5. The multilayer ceramic capacitor according to claim 1, wherein
a dimension of the multilayer body in the length direction is about 0.2 mm or more and about 10 mm or less;
a dimension of the multilayer body in the height direction is about 0.1 mm or more and about 10 mm or less; and
a dimension of the multilayer body in the width direction is about 0.1 mm or more and about 10 mm or less.

6. The multilayer ceramic capacitor according to claim 1, wherein each of the plurality of dielectric layers includes a CaZrO₃-based dielectric material or a Ca(Sr,Zr)O₃-based dielectric material as a main component.

7. The multilayer ceramic capacitor according to claim 6, wherein each of the plurality of dielectric layers includes a Mn compound, a Fe compound, a Cr compound, a Co compound, or a Ni compound as an auxiliary component.

8. The multilayer ceramic capacitor according to claim 1, wherein a thickness of each of the plurality of dielectric layers is about 0.2 μm or more and about 15 μm or less.

9. The multilayer ceramic capacitor according to claim 1, wherein a thickness of each of the plurality of dielectric layers is about 3 μm or more and about 10 μm or less.

10. The multilayer ceramic capacitor according to claim 1, wherein each of the plurality of internal electrode layers includes Ni, Cu, Ag, Pd, or Au, or an alloy including at least one of Ni, Cu, Ag, Pd, or Au.

11. The multilayer ceramic capacitor according to claim 1, wherein a thickness of each of the plurality of internal conductive layers is about 0.2 μm or more and about 2.0 μm or less.

12. The multilayer ceramic capacitor according to claim 1, wherein each of the first and second external electrodes includes a base electrode layer and a plated layer on the base electrode layer.

13. The multilayer ceramic capacitor according to claim 12, wherein the plated layer includes a Ni plated layer and a Sn plated layer on the Ni plated layer.

14. The multilayer ceramic capacitor according to claim 12, wherein the base electrode layer includes a metal component and at least one of a glass component or a ceramic component.

15. The multilayer ceramic capacitor according to claim 14, wherein the metal component includes at least one of one of Cu, Ni, Ag, Pd, Ag—Pd alloy, or Au.

16. The multilayer ceramic capacitor according to claim 14, wherein the glass component includes at least one of B, Si, Ba, Mg, Al, or Li.

17. The multilayer ceramic capacitor according to claim 14, wherein the ceramic component includes at least one of CaZrO₃, CaTiO, SrTiO₃, BaZrO₃, or TiO₂.

18. The multilayer ceramic capacitor according to claim 1, wherein a depth of each of the first, second, third, and fourth recesses is about 3 μm or more and 35 μm or less.

19. The multilayer ceramic capacitor according to claim 1, wherein a dimension of each of the first, second, third, and fourth recesses in the length direction of the multilayer body is about 50 μm or more and about 400 μm or less.

20. The multilayer ceramic capacitor according to claim 1, wherein
a depth of the first recess is about 10% or more and about 80% or less of a maximum thickness in the height direction of the first main surface-side external electrode;
a depth of the second recess is about 10% or more and about 80% or less of a maximum thickness in the height direction of the second main surface-side external electrode;
a depth of the third recess is about 10% or more and about 80% or less of a maximum thickness in the height direction of the third main surface-side external electrode; and
a depth of the fourth recess is about 10% or more and about 80% or less of a maximum thickness in the height direction of the fourth main surface-side external electrode.
